(19) United States
(12) Patent Application Publication
(10) Pub. No.: US 2020/0082630 A1
(43) Pub. Date: Mar. 12, 2020

(54) AUGMENTED REALITY PLATFORM AND METHOD FOR NAUTICAL APPLICATIONS

(71) Applicant: Anuj Sharma, New Delhi (IN)

(72) Inventor: Anuj Sharma, New Delhi (IN)

(21) Appl. No.: 16/279,349

(22) Filed: Feb. 19, 2019

(30) Foreign Application Priority Data
Sep. 7, 2018 (IN) 201811033797

(51) Int. Cl. G06T 19/00; G01B 9/021; G06F 3/0482; G02B 27/01

(52) U.S. Cl. CPC G06T 19/006; G01B 9/021; G02B 2027/0178; G02B 27/017; G06F 3/0482

(57) ABSTRACT

Described herein is a method and system providing complete global maritime mobility, operation and execution of any kind, anywhere, at any place by an authorised user, the system comprising live hologram projections “Digital Assets” of all on field “Physical Assets” including humans; and the system using Augmented Reality-Mixed Reality for creating live “Digital Twins” referred to as Hologram Projections of all available physical assets including humans in real world complete with monitoring, visualisation, communication, operations and execution capabilities; the system incorporating Data Infused Holograms with Artificial Intelligence Powered Descriptive, Predictive, Prescriptive and Cognitive (Fully Autonomous) Analytics and operative capabilities for Global Maritime World; each hologram of a physical asset having infinite data points as required.

CROSS-REFERENCE TO RELATED APPLICATION(S)

The present application claims priority to Indian Provisional Application 201811033797, entitled “The Nautica Project,” filed Sep. 7, 2018 in English, the entire contents of which are hereby incorporated by reference in their entirety.

### FIELD OF INVENTION

The present invention relates generally to augmented and/or mixed reality platforms suitable for use with Maritime, Shipping and Maritime Ports Command and Control, Security operations and Maritime assets with Artificial Intelligence (Ai) Powered Descriptive, Predictive, prescriptive and Cognitive (Fully autonomous) Analytics and operative capabilities for Global Maritime World.

### SUMMARY OF INVENTION

Disclosed embodiments of the present invention use Augmented Reality-Mixed Reality to create live “Digital Twins” referred to as Hologram Projections of all available “Physical Assets” including humans in real world complete with monitoring, visualization, communication, operations and execution capabilities incorporating Artificial Intelligence (Ai) Powered Descriptive, Predictive, prescriptive and Cognitive (Fully autonomous) Analytics and operative capabilities for a Global Maritime World. In some embodiments, the following hardware and software can be used to implement the platform: HoloLens AR-MR Glasses, META 2 AR-MR Glasses, Any AR-MR Glasses, Magic Leap MR Glasses, Unity 3D, Vuforia, Maya 3D, Microsoft .Net Platform, Azure Cloud Platform, HTML 5, CSS 3, JavaScript, Angular, jQuery, IOT tech, AI/Machine Learning, Python.

The present summary is provided only by way of example, and not limitation. Other aspects of the present invention will be appreciated in view of the entirety of the present disclosure, including the entire text, claims and accompanying figures.

### BRIEF DESCRIPTION OF ACCOMPANYING DRAWINGS

The foregoing detailed description of embodiments is better understood when read in conjunction with the appended drawing. For the purpose of illustrating the disclosure, there is shown in the present document example constructions of the disclosure; however, the disclosure is not limited to the specific methods disclosed in the document and the drawings.

The detailed description is described with reference to the accompanying figure. In the figure, the left-most digit(s) of a reference number identifies the figure in which the reference number first appears. The same numbers are used throughout the drawings to refer like features and components.

FIG. 1 to FIG. 37 provide a description of the capabilities and functionalities of an example embodiment of The NAUTICA PROJECT and its applications and example hardware for its implementation.

FIG. 1: shows a user wearing a wearable portion of a system, together with the choices available to the user to start the project.

FIG. 2: depicts the command options available to the user, including hologram box in AR and MR with Central command.

FIG. 3: depicts the hologram box in AR and MR with the option given to user to select any country.

FIG. 4: Refers to hologramic image of the country selected.

FIG. 5: depicts the Hologramic map of the selected country as a “IN AIR VIEW” and is broken by Nautica in assets and boundaries.

FIG. 6: is an “On ground” hologram projection of FIG. 5.

FIG. 7 A: depicts the hologram view of a ship asset.

FIG. 7B: depicts the screen with actual photo of the Ship Asset as chosen in FIG. 7A above, along with the various buttons available to user regarding the Ship Asset, such as buttons for communication, GPS Coordination, time estimate, with fuel sensor, weather sensors, cargo details, area of the ship and manual related to the Ship Asset.

FIG. 8: depicts the hologram screens of personnel/crew members.

FIG. 9: depicts screens for the Ship passengers.

FIG. 10: depicts the Cargo screens.

FIG. 11: depicts the illustration of an Engine Room.

FIG. 12: depicts the holographic screens of a living quarter.

FIG. 13: depicts the holographic screens of maintenance.

FIG. 14: depicts canteen and the further options available once a user selects the option ‘canteen’.

FIG. 15: depicts screens for issuing and deliveries schedule.

FIG. 16: depicts screen for Ship's main bridge or control room and its further details/options.

FIG. 17: depicts the hologram screens of a “Buoy” and its further details.

FIG. 18: depicts the holographic screens of a “Tug boat” and its further details.

FIG. 19: refers to the hologram of a “Port Berth” and its further details.

FIG. 20: depicts the “docking schedule” hologram screens.

FIG. 21: depicts the holographic screens of “Cranes” as a digital asset and its further options available to the user.

FIG. 22: depicts the holographic screens “CARGO CAPABILITY SCREEN” and its further options available to the user.

FIG. 23: depicts the holographic screens of CARGO CAPACITY and its further options available to the user.

FIG. 24: depicts the digital asset of “Weigh Bridge”.

FIG. 25: depicts the screens of REFERS TO HOLOGRAMIC IMAGE OF VEHICLE and its further options available to the user.

FIG. 26: depicts the screens of STORAGE TANK HOLOGRAM and its further options available to the user.

FIG. 27: depicts HOLOGRAM OF PORT OPEN STORAGE-CARGO AREA IN AR-MR and its further options available to the user.

FIG. 28: refers to Hologram of a Lighthouse and its further options available to the user.

FIG. 29: refers to HOLOGRAM OF SECURITY TOWER and its further options available to the user.

FIG. 30: depicts the digital asset of a “Train and Railway Lines” and its further options available to the user.

FIG. 31: depicts the screens of “Port Channel and Outer Sea” and its further options available to the user.

FIG. 32: depicts the screens of a Jetty and its further options available to the user.

FIG. 33: depicts an example of screens of NAUTICA AI-ARTIFICIAL INTELLIGENCE COMMMAND.

FIG. 34: depicts an example of further screens of NAUTICA AI that open after FIG. 33.

FIG. 35: depicts the HOLOGRAM OF ROTATING EARTH.

FIG. 36: depicts the Digital Asset of a “DRONE/UNMANNED ARIAL VEHICLE (UAV)”.

FIG. 37: a schematic representation of a computer usable with embodiments of the present system.

### DETAILED DESCRIPTION OF EMBODIMENTS

The Nautica Project can use Augmented Reality-Mixed Reality to create live “Digital Twins” referred to as Hologram Projections of available “Physical Assets” including humans in real world complete with monitoring, visualization, communication, operations and execution capabilities incorporating Artificial Intelligence (Ai) Powered Descriptive, Predictive, prescriptive and Cognitive (Fully autonomous) Analytics and operative capabilities for Global Maritime World.

Elements of the present invention can provide:
I. Live Hologram projections “Digital Assets” of all on field “Physical Assets” including humans
II. Data Infused Holograms with Artificial Intelligence (Ai) Powered Descriptive, Predictive, prescriptive and Cognitive (Fully autonomous) Analytics and operative capabilities for Global Maritime World. Each Hologram of a Physical asset has infinite data points as required.
III. NAUTICA provides live holographic visualizations of all Maritime assets and every surface area of the earth; all seas, waterways and land.
IV. Live visualizations in holographic visualizations with Ai Analytics in real time leads to total mission awareness, planning, rehearsal, and execution-operations.
V. NAUTICA creates Absolute Situational awareness by providing real-time information on the current situation and execution-operational capabilities from NAUTICA itself. Nautica can be accessed anytime anywhere and provides complete mobility for entire operations. No Brick and Mortar facilities are required to operate Nautica.
VI. NAUTICA provides complete global Maritime mobility, operation and execution anytime, anywhere, anyplace and by any user authorized to access Nautica. All Function of NAUTICA are “Touch” and “Voice Command “Enabled.
VII. NAUTICA can be developed in AR (Augmented Reality-MR (Mixed Reality) Holographic screens and projections
VIII. NAUTICA can also be developed in software mode available in computers, tablets, mobile phones and smart screens
IX. NAUTICA should be operated on a secured-encrypted environment due to its sensitivity and strategic deployment capabilities.
X. Authority levels of NAUTICA access per screen and functions can be decided as per user requirements.
XI. NAUTICA Holograms can also be held by hand and moved around.

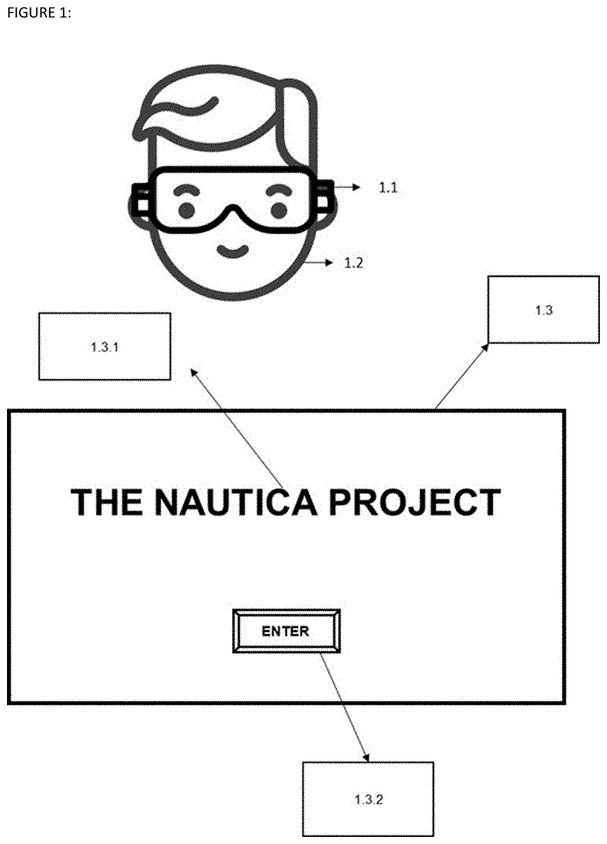

### Legend for FIG. 1:

1.1 SMART GLASSES WITH AR-MR

1.2 USER (HUMAN/ROBOT/ALIEN)

1.3 HOLOGRAMIC BOX IN AR-MR

1.3.1 HOLOGRAMIC TEXT IN AR-MR

1.3.2 CLICKABLE BUTTON OR “VOICE COMMAND ACTIVATED”

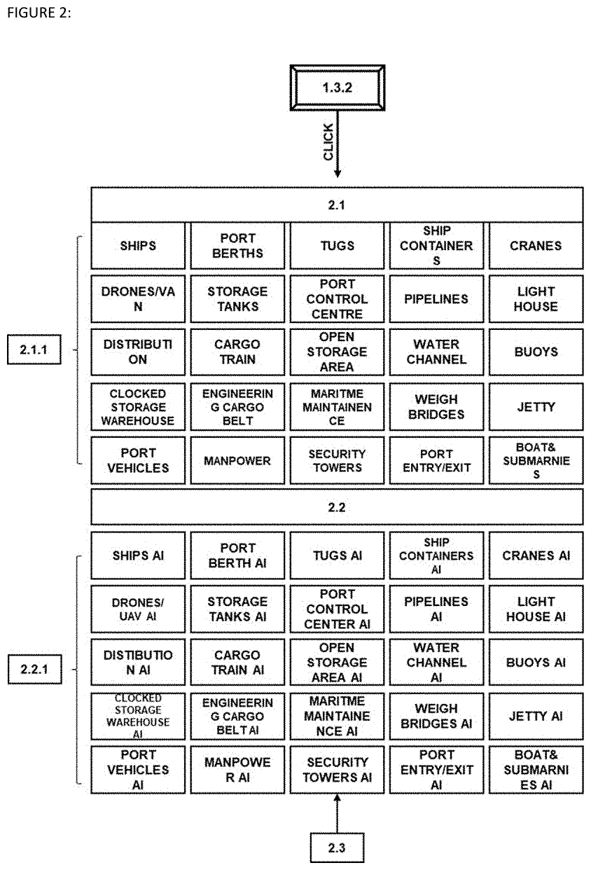

### Legend for FIG. 2:

1.3.2 REFERS TO CLICKABLE BUTTON OR “VOICE COMMAND ACTIVATED” BUTTON IN FIG. 1 OF THE DOCUMENT

2.1 NAUTICA CENTRAL COMMAND

2.1.1 EVERY ROW AND COLUMN IS CLICKABLE OF THE CENTRAL COMMAND

2.2 NAUTICA ARTIFICIAL INTELLIGENCE

2.1.1 EVERY ROW AND COLUMN IS CLICKABLE OF THE NAUTICA ARTIFICIAL INTELLIGENCE

2.3 HOLOGRAM BOX IN AR-MR

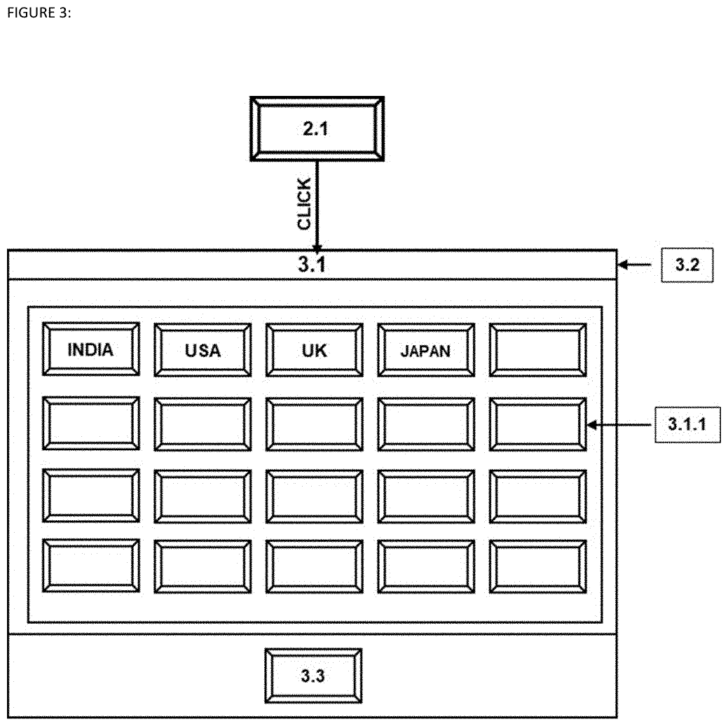

### Legend for FIG. 3:

2.1 REFERS TO NAUTICA CENTRAL COMMAND IN THE FIG. 2 OF THE DOCUMENT

3.1 REFERS TO SHIPS BASED ON SELECTION IN 2.1

3.1.1 ALL BUTTONS ARE CLIKABLE BUTTON FOR ALL COUNTRIES OF THE WORLD

3.2 HOLOGRAM BOX IN AR-MR

3.3 BUTTON FOR COMBINING ALL COUNTRIES OF THE WORLD

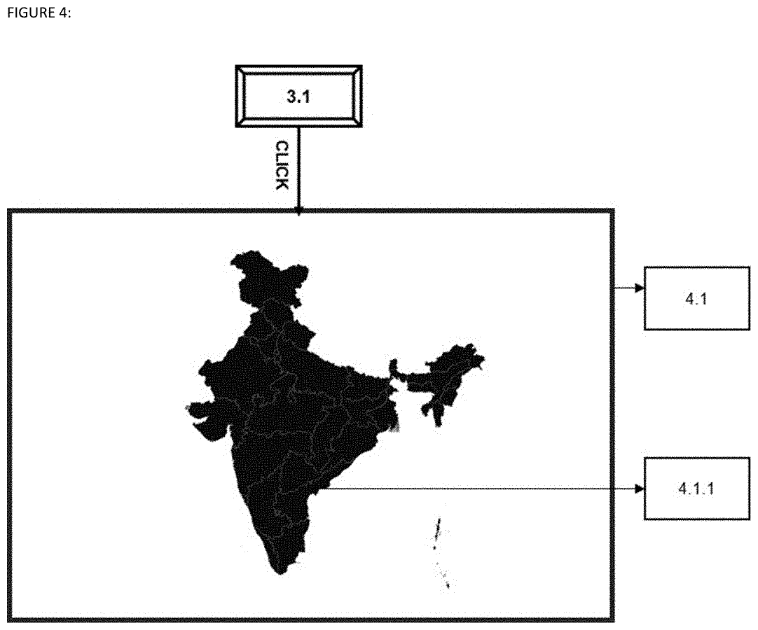

### Legend for FIG. 4:

3.1 REFERS TO SELECTION MADE IN FIG. 3 OF THE DOCUMENT

4.1 HOLOGRAMIC IMAGE OF COUNTRY OPENS IN AR-MR

4.1.1 HOLOGRAM OF THE COUNTRY SELECTED

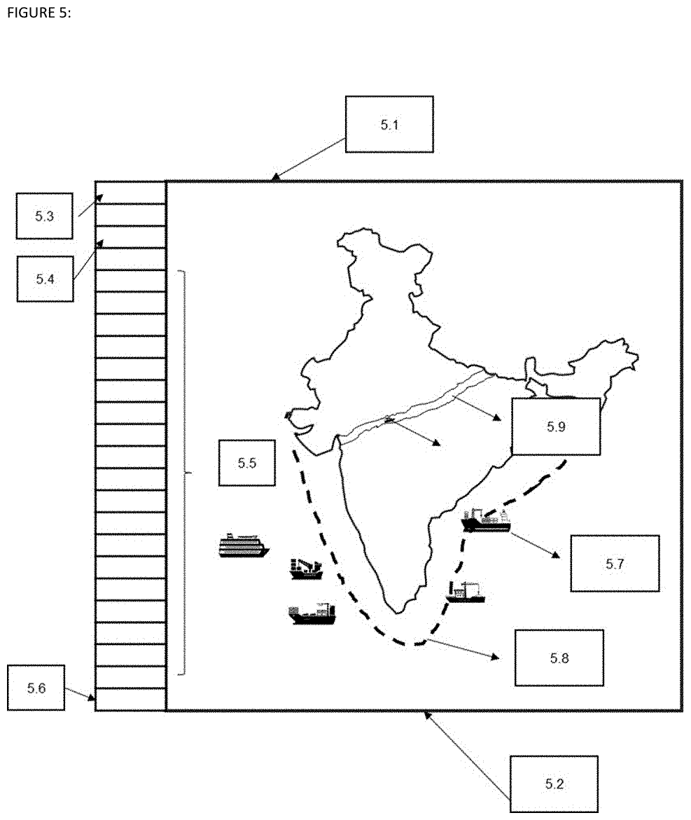

### Legend for FIG. 5:

5.1 “IN AIR VIEW”

5.2 HOLOGRAM BOX IN AR-MR

5.3 BACK BUTTON

5.4 NAUTICA CENTRAL COMMAND BUTTON

5.5 ALL COUNTRIES BUTTON

5.6 WORLD BUTTON

5.7 HOLOGRAM OF ALL SHIPS APPEAR IN BOTH NATIONAL AND INTERNATIONAL WATERS AROUND THAT COUNTRY

5.8 A COLOURED LINE IN THE HOLOGRAM ALSO SHOWS MARITIME BOUNDARY AROUND THAT COUNTRY

5.9 RIVERS ARE ALSO SHOWN IN THE HOLOGRAM

5.10 SHIPS AND BOATS IN THE RIVER

NOTE: ALL COUNTRIES WILL HAVE TO BE MADE IN NAUTICA LIKE ABOVE ILLUSTRATION

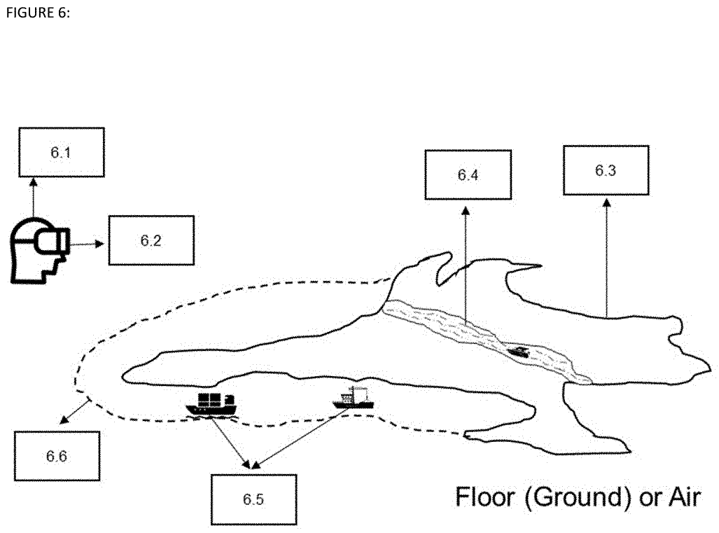

### Legend for FIG. 6:

6.1 USER

6.2 SMART GLASS

6.3 HOLOGRAM PROJECTION OF INDIA ON GROUND

6.4 HOLOGRAMIC IMAGE OF RIVER

6.5 HOLOGRAMIC IMAGE OF SHIPS

6.6 INTERNATIONAL MARITIME BOUNDARY HOLOGRAM

NOTE: ALL MARITIME SHIPPING, WATERWAYS, PORT MACHINERY, EQUIPMENTS, BUILDING, WORKERS ARE ALL ASSETS.

NAUTICA IS CREATING A “DIGITAL TWIN” OF THAT “PHYSICAL ASSET”. THE DIGITAL TWIN IS A “LIVE” REPLICATION.

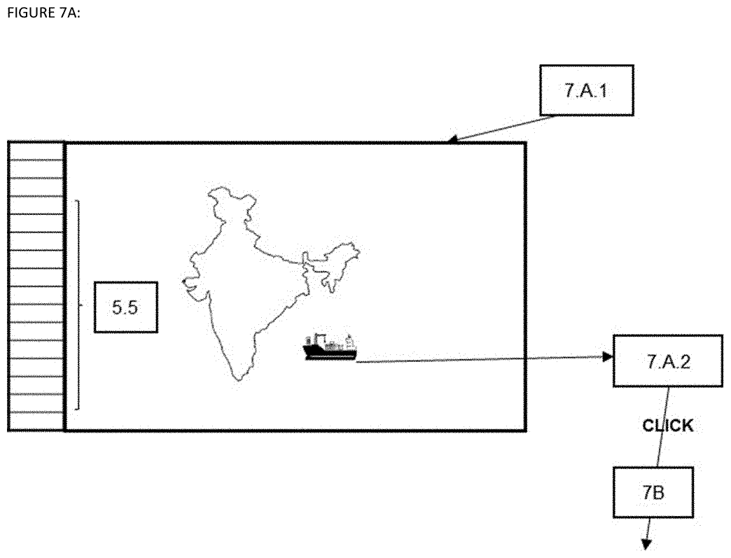

### Legend for FIG. 7A:

5.5 ALL COUNTRIES BUTTON

7.A.1 HOLOGRAM BOX

7.A.2 SHIP HOLOGRAM

7B REFERS TO FIG. 7B IN THE DOCUMENT

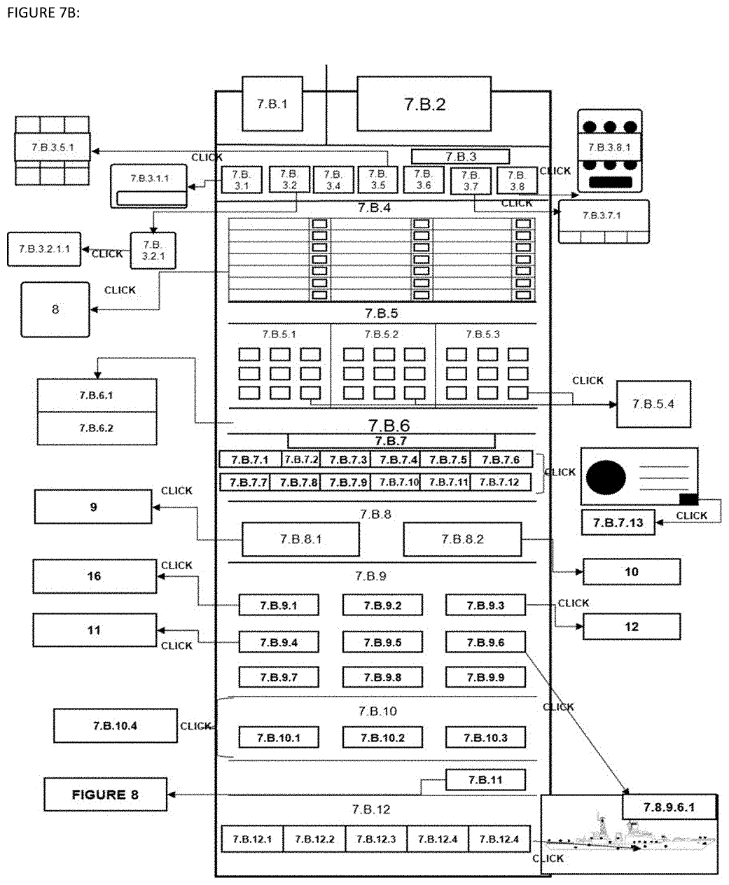

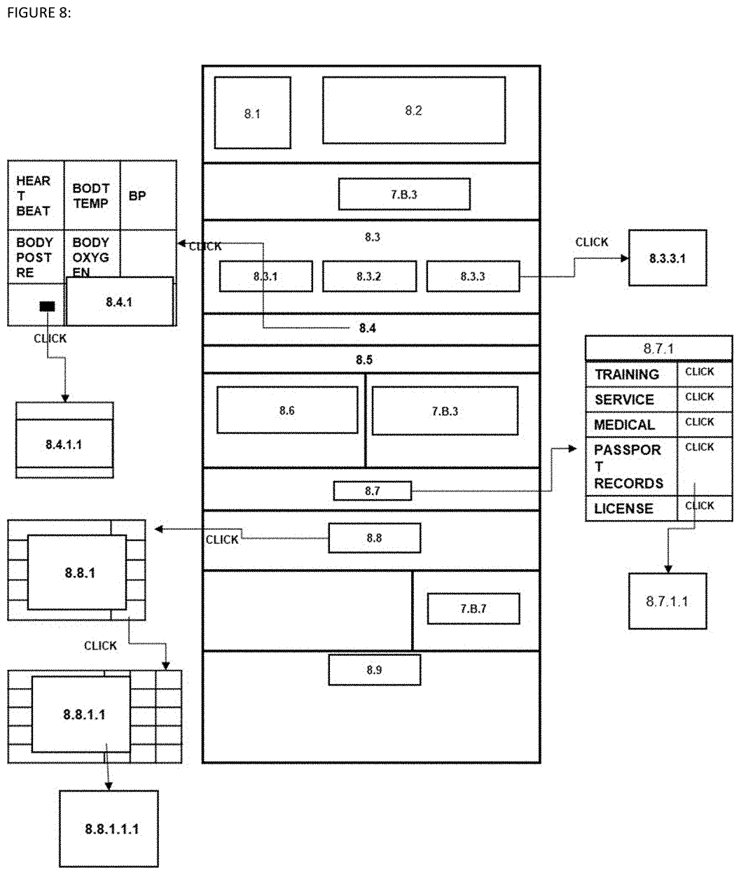

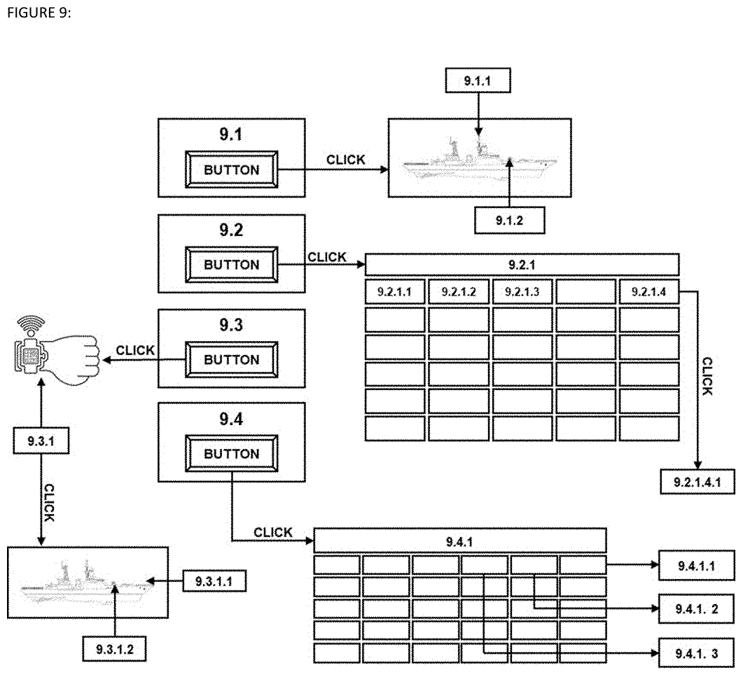

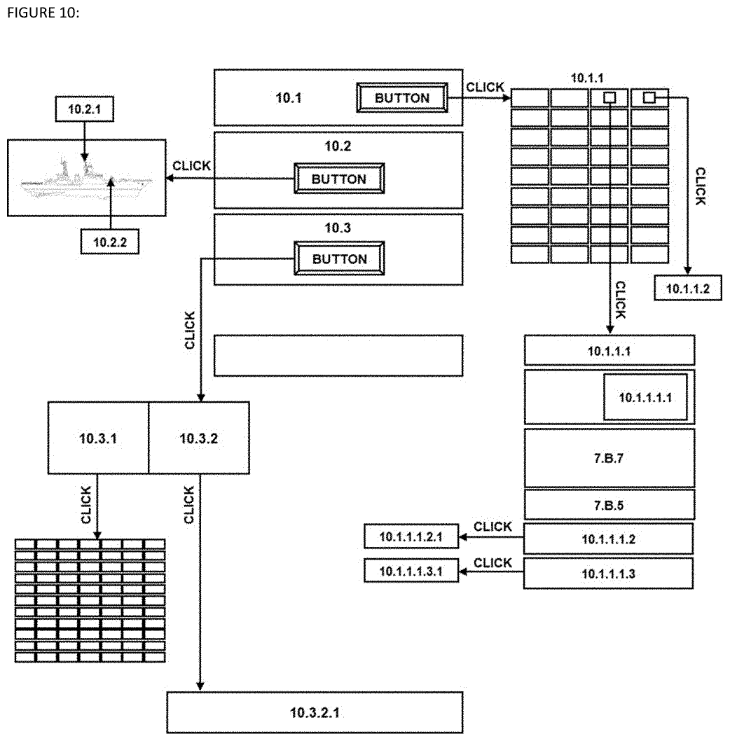

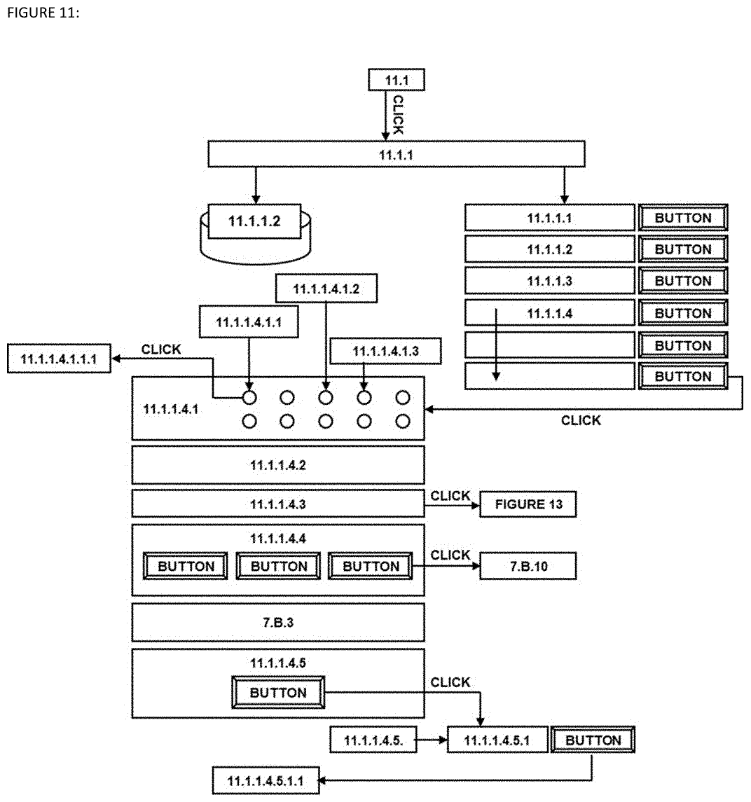

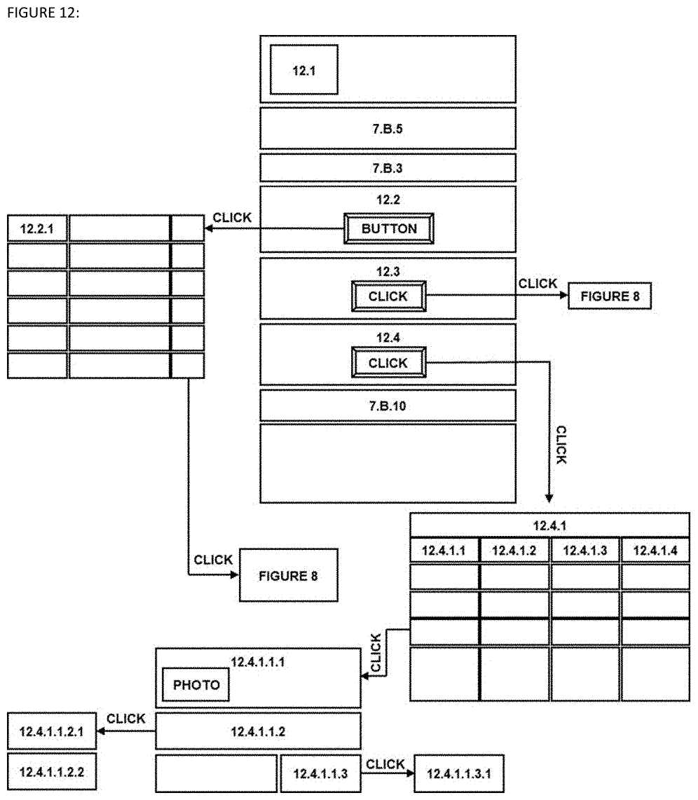

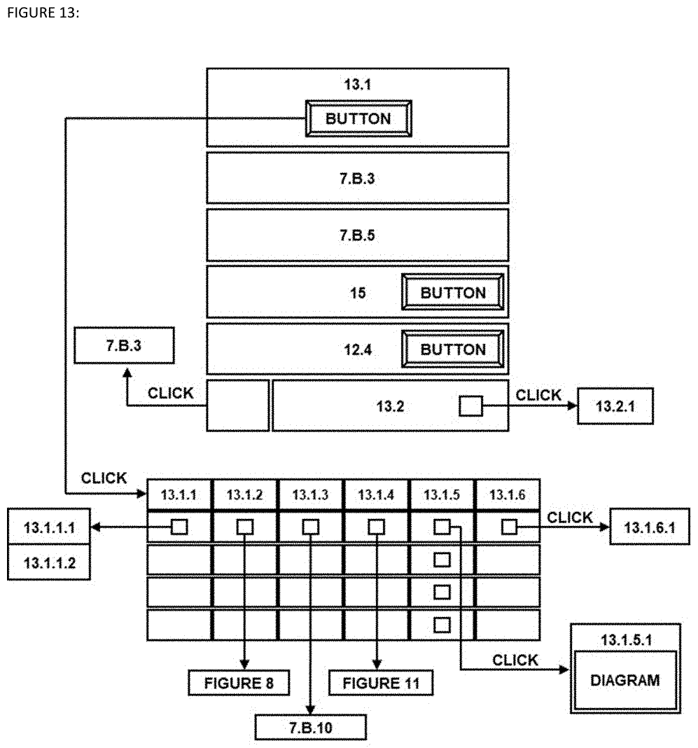

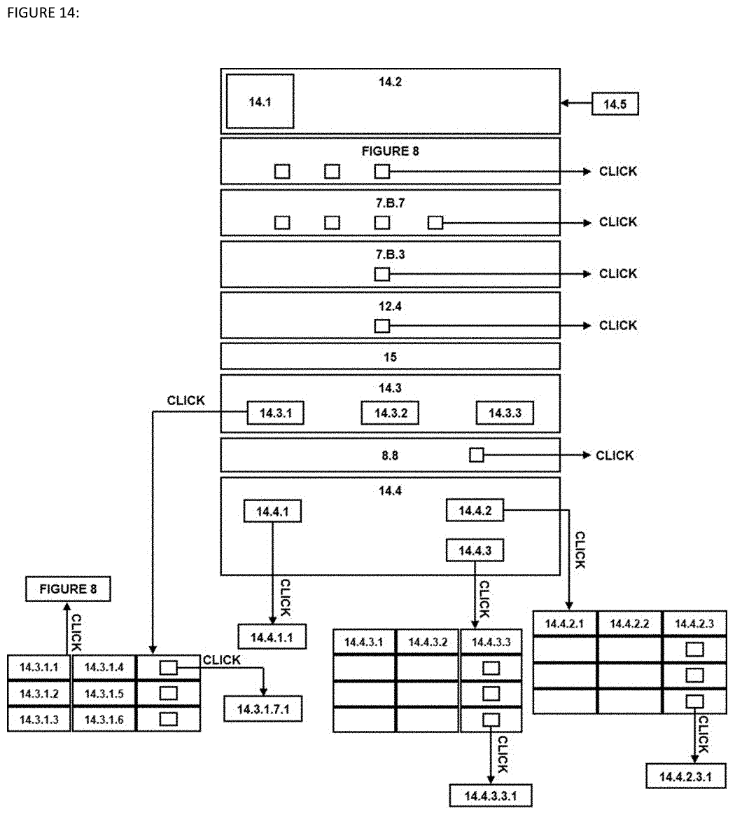

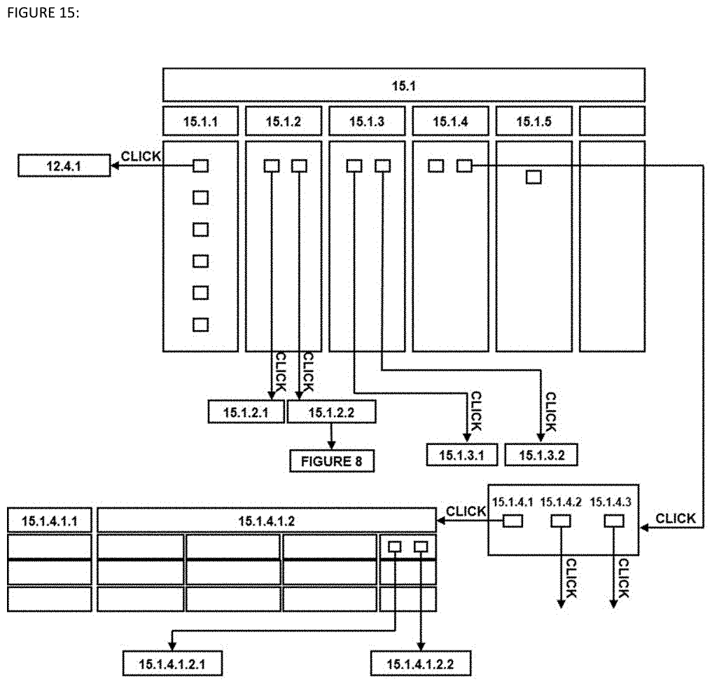

### Legend for FIG. 7B:

| | |
|---|---|
| 7.B.1 ACTUAL PHOTO OF | 7.B.6 GPS COORDINATES |
| ASSET | (CHANGES FOR EVERY |
| 7.B.2 DETAILS OF THE SHIP | HOLOGRAM OF EVERY |
| 7.B.3 COMMUNICATION | ASSET AS PER LIVE |
| SECTION | LOCATION) |
| 7.B.3.1 WHATSAPP | 7.B.6.1 ESTIMATED TIME OF |
| 7.B.3.1.1 TEXT SCREENS | ARRIVAL |
| 7.B.3.2 INTERNET SEARCH | 7.B.6.2 DEPARTURE TIME |
| 7.B.3.2.1 GOOGLE ICON | 7.B.7 SENSORS OF THE SHIP |
| 7.B.3.2.1.1 GOOLE SEARCH | 7.B.7.1 FUEL |
| 7.B.3.3 SPEAKER | 7.B.7.2 NAUTICAL MILES |
| 7.B.3.4 MUTE | 7.B.7.3 HUMIDITY |
| 7.B.3.5 TRANSLATE | 7.B.7.4 WIND |
| 7.B.3.5.1 CLICK ON ANY | 7.B.7.5 DEPTH |
| LANGAUGE AND AI | 7.B.7.6 WAVES |
| (ARTIFICIAL INTELLIGENE | 7.B.7.7 AIR |
| LANGUAGE TRANSLATOR) | 7.B.7.8 TEMPARTURE |
| CONVERTS NAUTICA TO | 7.B.7.9 SPEED |
| THAT LANGAUGE | 7.B.7.10 POWER |
| 7.B.3.6 EMAIL | 7.B.7.11 ALLTITUDE |
| 7.B.3.7 SKYPE | 7.B.7.12 SEA LEVEL |
| 7.B.3.7.1 SKYPE FEED OPENS | 7.B.7.13 EACH OF THE |
| 7.B.3.8 PHONE | BUTTONS FROM 7.B.7.1 TO |
| 7.B.3.8.1 DIALPAD FOR PHONE | 7.B.7.12 IS CLICKABLE AND |
| 7.B.4 CREW DETAILS | OPENS A SCREEN |
| 8 REFERS TO FIG. 8 IN THE | WHICH HAS AI BASED |
| DOCUMENT | ANALYTICS OF |
| 7.B.5 VIDEO FEED | EACH SENSOR |
| 7.B.5.1 NORMAL VISION | |
| 7.B.5.2 NIGHT VISION | |
| 7.B.5.3 THERMAL VISION | |
| 7.B.5.4 EXPANDS EACH FEED | |
| (VIDEO FEED ALSO HAS | |
| FACE + ARM& AMMUNITION | |
| DETECTION FOR | |
| PASSANGERS & PIRATES) | |

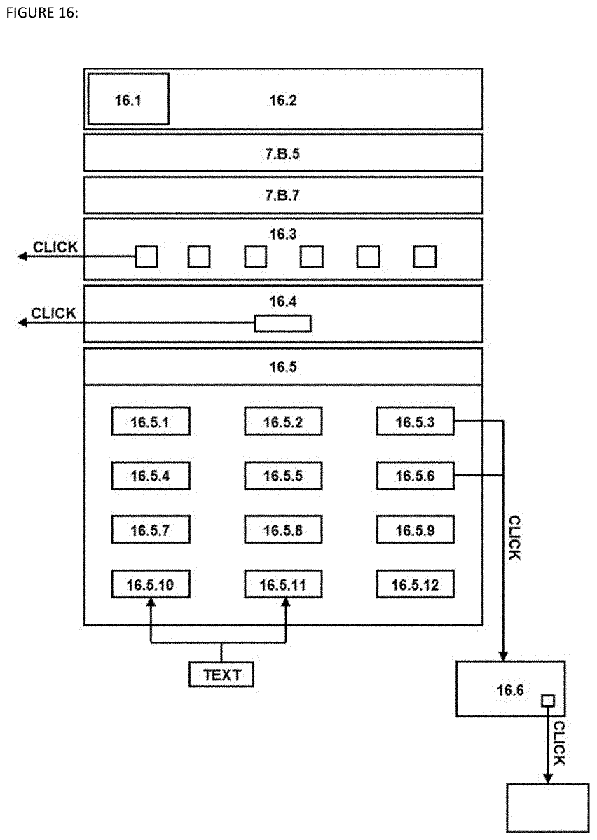

### Legend for FIG. 7B:

| | |
|---|---|
| 7.B.8 CARGO DETAILS | 7.8.9.7 LICENSES |
| 7.B.8.1 PASSENGERS | 7.8.9.8 CANTEEN |
| 9 REFERS TO FIG. 9 IN | 7.8.9.9 OTHERS |
| THE DOCUMENT | 7.B.10 MANUALS |
| 7.B.8.2 GOODS | 7.B.10.1 OPERATION |
| 10 REFERS TO FIG. 10 | MANUALS |
| IN THE DOCUMENT | 7.B.10.2 EMERGENCY |
| 7.B.9 AREAS OF SHIPS | MANAUALS |
| 7.B.9.1 SHIP BRIDGE | 7.B.10.3 BLUEPRINTS |
| 16 REFERS TO FIG. 16 | OF SHIP |
| IN THE DOCUMENT | 7.B.10.4 DIGITAL SCANS |
| 7.B.9.2 CANTEEN | OF MANUAL OPENS |
| 7.8.9.3 LIVING QUARTER | 7.B.11 DUTY ROSTERS |
| 12 REFERS TO FIG. 12 | 8 REFERS TO FIG. 8 OF |
| IN THE DOCUMENT | THE DOCUMENT |
| 7.8.9.4 ENGINE ROOM | 7.B.12 COMMUNICATION |
| 11 REFERS TO FIG. 11 | SECTIONS (WITH OTHER PARTIES) |
| IN THE DOCUMENT | 7.B.12.1 NAVY |
| 7.8.9.5 MAINTAINENCE | 7.B.12.2 COAST GUARD |
| 7.8.9.6 PERSONAL LOCATOR | 7.B.12.3 MEDICAL |
| 7.8.9.6.1 SCREEN OPENS | 7.B.12.4 POLICE |
| UP WITH SHOWING | 7.B.12.5 IMMIGRATION |
| EACH PERSONAL | 7.8.9.6.1 SCREEN OPENS UP |
| ON THE SHIP | WITH SHOWING EACH |
| | PERSONNEL/CREW ON THE SHIP |

### Legend for FIG. 8:

8.1 ACTUAL PHOTO OF CREW MEMBER

8.2 PERSONAL DETAILS OF CREW

7.B.3 REFERS TO COMMUNICATION SECTION OF FIG. 7

8.3 VIDEO FEED

8.3.1 NORMAL VIEW

8.3.2 THERMAL VIEW 8.3.3 NIGHT VISION VIEW 8.3.3.1 VIDEO FEED SCREEN (AI-ARTIFICIAL INTELLIGENCE BASED FACE+ARMS/AMMUNATION LOCATOR

8.4 VITALS

8.4.1 DETAILED VITALS OF CREW MEMBER

8.4.1.1 DETAILED AI-ARTIFICIAL INTELLIGENCE ANALYTICS SCREEN GIVING WEEKLY/MONTHLY AND HOUR WISE DATA

8.5 GPS COORDINATES

8.6 RANKING OFFICER DETAILS

7.B.3 REFERS TO COMMUNICATION SECTION OF FIG. 7

8.7 RECORDS

8.7.1 OPENS UP RECORD OF THE CREW MEMBER

8.7.1.1 DIGITAL SCREEN OPENS UP

8.8 DUTY ROSTER

8.8.1 DAY WISE/MONTH WISE DUTY SCHEDULE& ROSTERS

8.8.1.1 ATTENDANCE RECORDS OPEN

8.8.1.1.1 DIGITAL SCANS OF ATTENDANCE RECORD OPENS

7.B.7 SENSORS SECREEN FROM FIG. 7 OF THIS DOCUMENT

8.9 KEY SPECIALITIES OF CREW MEMBER.

### Legend for FIG. 9:

9.1 SHIP PASSENGER DISTIBUTION

9.1.1 BLUEPRINT OF THE SHIP

9.1.2 EACH PASSENGER SHOWN

9.2 SHIP PASSENGER LIST

9.2.1 DETAILS OF PASSENGER

9.2.1.1 NAME

9.2.1.2 AGE

9.2.1.3 NATIONALITY

9.2.1.4 PASSENGER RECORDS SCAN

9.2.1.4.1 DIGITAL SCANS OF PASSENGER RECORDS OPEN UP

9.3 SHIP PASSENGER LOCATOR

9.3.1 EACH OF THE PASSENGER GIVEN A WRIST BAND WITH GPS LOCATOR+RFID TAG

9.3.1.1 BLUE PRINT OF THE SHIP

9.3.1.2 GPS LOCATION OF THE PASSENGER, CLICKING ON IT GIVES DETAILS OF THAT PASSENGER

9.4 SHIP PASSENGER ANALYTICS

9.4.1 AI BASED EACH PASSENGER ANALYTICS (ALL TYPES)

9.4.1.1 HER/HIS SPENDING HABITS

9.4.1.2 PASSENGER FOOD ORDERS

9.4.1.3 AREAS OF SHIP VISITED

### Legend for FIG. 10:

10.1 CARGO LIST

10.1.1 CARGO DETAILS

10.1.1.1 CARGO DETAILS TABLE

10.1.1.1.1 ACTUAL PHOTOS

7.B.7 REFERS TO SENSOR FEED FROM FIG. 7 IN THE DOCUMENT

7.B.5 REFERS TO VIDEO FEED FROM FIG. 7 IN THE DOCUMENT

10.1.1.1.2 WEIGHT

10.1.1.1.2.1 WEIGHT IN TONS

10.1.1.1.3 CUSTOM RECORDS

10.1.1.1.3.1 DIGITAL SCANS

10.2 CARGO BLUEPRINT

10.2.1 GPS LOCATION OF CARGO CONTAINER/GOOD

10.2.2 SHIP BLUE PRINT

10.3 CARGO LOADING/UNLOADING

10.3.1 LOADING/UNLOADING SCHEDULES

10.3.2 LOADING/UNLOADING PERFORMANCE

10.3.2.1 LOADING TIME METRICS+AI ANALYTICS (SCREENS FOR EACH CARGO CONTAINER/GOODS TO BE MADE

### Legend for FIG. 11:

11.1 REFERS TO ENGINE

11.1.1 OPENS TO HOLOGRAMIC SCREEN

11.1.1.1 ENGINE PISTON

11.1.1.2 ENGINE VALVE

11.1.1.3 ENGINE CHAMBER

11.1.1.4 ALL ENGINE PARTS/SECTIONS LISTED

11.1.1.4.1 STATUS SENSORS (ALL TYPES)

11.1.1.4.1.1 GAUGE

11.1.1.4.1.1.1 SCREEN OF THE SENSOR WITH ANALYTICS OPEN

11.1.1.4.1.2 TEMPRATURE

11.1.1.4.1.3 HUMIDITY

11.1.1.4.2 DETAILS OF ENGINE PART

11.1.1.4.3 SERVICE/MAITAINANCE RECORDS

13 REFERS TO FIG. 13 OF THE DOCUMENT

11.1.1.4.4 MANUALS OF THE ENGINE

7.B.10 REFERS TO MANUAL SECTION OF THE FIG. 7

7.B.3 REFERS TO COMMUNICATION SECTION OF THE FIG. 7

11.1.1.4.5 AI BASED ANALYTICS OF ENGINE PART

11.1.1.4.5.1 PARAMETERS TO BE MEASURED FOR ENGINE PARTS PERFORMANCE

11.1.1.4.5.1.1 GRAPHICS, VISUAL DIAGRMAS AND AI ANALYTICS

### Legend for FIG. 12:

12.1 ACTUAL PHOTO

7.B.5 REFERS TO VIDEO FEED SECTION IN THE FIG. 7 OF THIS DOCUMENT

7.B.3 REFERS TO COMMUNICATION SECTION IN THE FIG. 7 OF THIS DOCUMENT

12.2 LIVING QUARTERS ALLOCATION

12.2.1 TABLE FOR DETAILS ABOUT QUARTERS

8 REFERS TO FIG. 8 OF THE DOCUMENT

12.3 DUTY ROSTERS FOR LIVING QUARTER

8 REFERS TO FIG. 8 OF THE DOCUMENT

12.4 STOCK FOR LIVING QUARTERS

12.4.1 DETAILS OF ITEM USED FOR LIVING QUARTERS

12.4.1.1 ITEMS

12.4.1.2 ISSUED TO AND BY WHOM

12.4.1.3 USED

12.4.1.4 BALANCE

12.4.1.4.1 DETAILS

12.4.1.4.2 RECORDS

12.4.1.4.2.1 DIGITAL SCANS OF ITEM SPECIFICATION

12.4.1.4.2.2 DIGITAL SCAN OF ITEMS PROCUREMENT

12.4.1.4.3 BUTTON FOR AI

12.4.1.4.3.1 AI BASED ANALYTICS SCREENS

7.B.10 REFERS TO MANUAL SECTION IN FIG. 7 (MODELLED FOR THIS SECTION

### Legend for FIG. 13:

13.1 CURRENT TASKS

13.1.1 TASK

13.1.1.1 DIGITAL SCANS OF TASK ORDER

13.1.1.2 TASK HISTORY

13.1.2 CREW

8 REFERS TO FIG. 8 IN THE DOCUMENT

13.1.3 MANUALS

7.6.10 REFERS TO MANUAL SECTION OF THE FIGURE (MODELLED FOR THIS SECTION

13.1.4 MECHANICAL COMPONENTS)

11 REFERS TO FIG. 11 IN THE DOCUMENT

13.1.5 CURRENT STATUS

13.1.5.1 COMPLETION STATUS (PICTURES/DIAGRAMS)

13.1.6 AI ANALYTICS

13.1.6.1 AI BASED ANALYTICS SCREENS

7.B.3 REFERS TO COMMUNICATION SECTION IN THE FIG. 7.B OF THE DOCUMENT

7.B.5 REFERS TO VIDEO FEED SECTION IN THE FIURE 7.B OF THE DOCUMENT

15 REFERS TO FIG. 15 OF THE DOCUMENT

12.4 REFERS TO STOCK IN THE FIG. 12 OF THE DOCUMENT

13.2 MAINTAINENCE RECORDS

13.2.1 RECORDS SCREEN OPEN

7.B.3 COMMUNICATION TO MANFACTURER (COMMUNICATION SECTION IN THE FIG. 7.8 OF THE DOCUMENT)

### Legend for FIG. 14:

| | |
|---|---|
| 14.1 ACTUAL PHOTO | 8.8 REFERS TO DUTY |
| OF CANTEEN | ROSTER IN FIG. 8 OF |
| 14.2 DETAILS OF | THE DOCUMENT |
| GPS COORDINATES | 14.4 SECTION DETAILS |
| 8 REFERS TO FIG. 8 FROM | 14.4.1 CANTEEN BLUEPRINT |
| DOCUMENT (CREW SECTION) | 14.4.1.1 SEATING PLAN |
| 7.B.7 REFERS TO SENSOR | OF CANTEEN |
| SECTION FROM FIG. | 14.4.2 FOOD WASTAGE |
| 7 IN THE DOCUMENT | 14.4.2.1 ITEM |
| 7.B.3 REFERS TO | 14.4.2.2 WASTE |
| COMMUNICATION SECTION | 14.4.2.3 AI |
| FROM FIG. 7 IN THE DOCUMENT | 14.4.2.3.1 AI BASED |
| 12.4 REFES TO CANTEEN | ANALYTICS |
| STOCK FROM SECTION IN | 14.4.3 FOOD CONSUMPTION |
| THE FIG. 12 OF THE DOCUMENT | 14.4.3.1 ITEM |
| 15 REFERS TO ISSUING& | 14.4.3.2 WASTE |
| DELIVERY SCHEDULE IN | 14.4.3.3 AI |
| FIG. 15 OF THE DOCUMENT | 14.4.3.3.1 AI BASED |
| 14.3 MENU | ANALYTICS |
| 14.3.1 DAILY | 14.5 HOLOGRAM BOX |
| 14.3.1.1 TO 14.3.1.3 CREW COOKS | |
| 8 REFERS TO CREW SECTION | |
| IN FIG. 8 OF THE DOCUMENT | |
| 14.3.1.4 BREAKFAST | |
| 14.3.1.5 LUNCH | |
| 14.3.1.6 DINNER | |
| 14.3.1.7 FEEDBACK AND | |
| SURVEY REPORTS | |
| 14.3.2 WEEKLY | |
| 14.3.3 MONTHLY | |

### Legend for FIG. 15:

15.1 ISSUING AND DELIVERIES SCHEDULE

15.1.1 ITEM

12.4.1 REFERS TO SECTION UDER ITEMS IN FIG. 12 OF THE DOCUMENT

15.1.2 ISSUED TO

15.1.2.1 DIGITAL SCANS OF RECORDS

15.1.2.2 ISSUED TO PERSON DETAILS

8 REFERS TO CREW SECTION IN FIG. 8 OF THE DOCUMENT

15.1.3 IN CHARGE DETAILS

15.1.3.1 DIGITAL SCANS OF RECORDS OPEN

15.1.3.2 IN CHARGE PERSON FROM FIG. 8 OPENS FROM THIS DOCUMENT

15.1.4 DELIVERIES SCHEDULE

15.1.4.1 DAY

15.1.4.1.1 ITEM

15.1.4.1.2 DELIVERY SCHEDULES

15.1.4.1.2.1 AI BASED ANALYTICS SCREEN PARAMETERS

15.1.4.1.2.2 DIGITAL SCANS OF ALL RECORDS

15.1.4.2 MONTH (CLICKABLE)

15.1.4.3 YEAR (CLICKABLE)

15.1.5 BALANCE

### Legend for FIG. 16:

16.1 REFERS TO ACTUAL PHOTO OF BRIDGE

16.2 DETAILS OF BRIDGE

7.B.5 REFERS TO VIDEO FEED SECTION OF FIG. 7 IN THE DOCUMENT

7.B.7 REFERS TO COMMUNICATION SECTION OF FIG. 7 IN THE DOCUMENT

16.3 CREW DETAILS (EACH BUTTON IS CLICKABLE OF EVERY CREW)

16.4 DUTY ROSTERS (EACH BUTTON IS CLICKABLE)

16.5 BRIDGE OPERATIONS

16.5.1 NAVIGATION

16.5.2 ANTI COLLISION

16.5.3 ROUTE PLOTTING

16.5.4 SHIP SYSTEMS

16.5.5 WEATHER & SEA CONDITIONS

16.5.6 NAUTICA CENTRAL COMMAND

16.5.7 TO 16.5.12 ARE PORGRAMMABLE BUTTONS FOR OTHER OPERATIONS

16.6 ALL BUTTONS FROM 16.5.1 TO 16.5.12 ARE CLICKABLE AND OPEN TO A NEW SCREEN GIVING DETAILS ABOUT EACH OPERATIONS

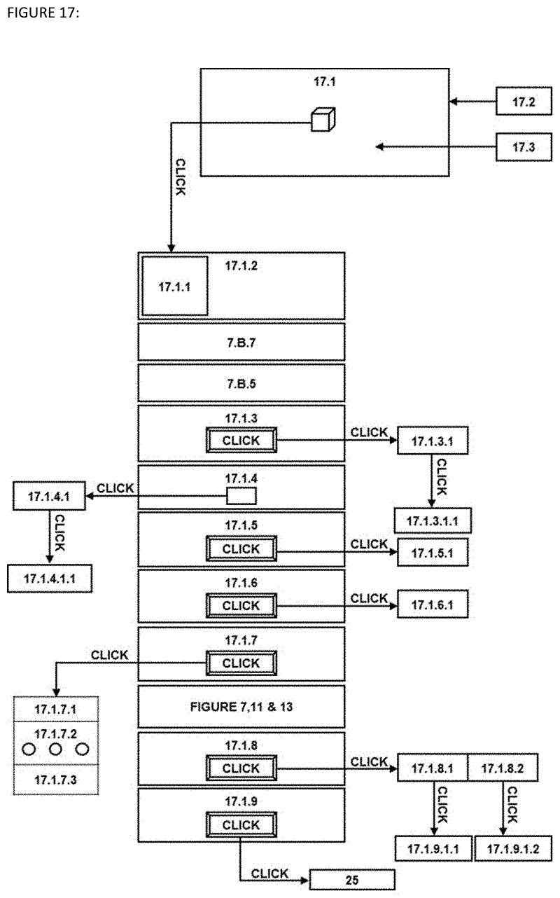

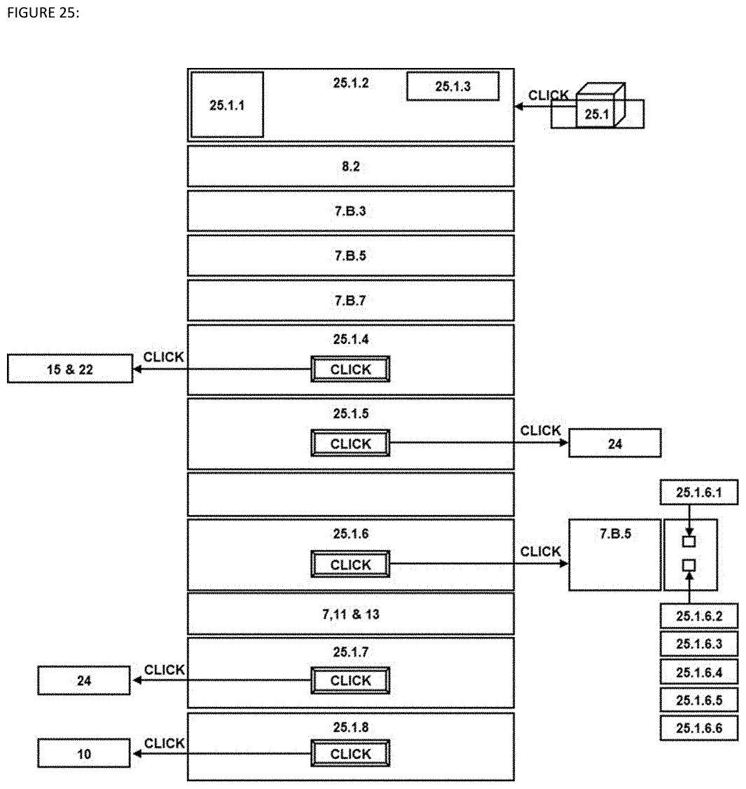

### Legend for FIG. 17:

| | |
|---|---|
| 17.1 HOLOGRAM OF A BUOY | 7, 11, 13 REFERS TO |
| 17.1.1 ACTUAL PHOTO OF BUOY | MANUAL SECTION IN |
| 17.1.2 DETAILS ABOUT BUOY | THESE FIGURES (MODELLED |
| 7.B.7 SENSOR FEED FROM | FOR THIS SECTION) |
| FIG. 7 OF THE DOCUMENT | 17.1.8 WARNING LIGHT |
| 7.B.5 VIDEO CAMERA FEED | SYSYTEM |
| FROM FIG. 7 OF THE | 17.1.8.1 ON |
| DOCUMENT | 17.1.8.1.1 WARNING LIGHTS |
| 17.1.3 TSUNAMI WARNING | CAN BE SWITCHED ON |
| SYSTEMS | 17.1.8.2 OFF |
| 17.1.3.1 SEA LEVEL LIVE | 17.1.8.1.2 WARNING LIGHTS |
| ANALYTICS FOR SUNAMI | CAN BE SWITCHED OFF |
| 17.1.3.1.1 AI BASED ANALYTICS | 17.1.9 AUTONOMOUS FLOAT |
| FOR TSUNAMI | OF BUOY |
| 17.1.4 WATER/SEA SWELL | 25 REFERS TO FIG. 25 OF |
| PERIODS | THE DOCUMENT |
| 17.1.4.1 WATER SWELL | 17.2 HOLOGRAM OF BUOY |
| PERIODS ANALYTICS | 17.3 WATER HOLOGRAM |
| 17.1.4.2 AI BASED ANALYTICS | |
| SCREEN | |
| 17.1.5 WAVE HEIGHTS | |
| 17.1.5.1 SAME AS 17.1.4.1 | |
| (SWEEL PERIODS ANALYTICS | |
| BUT FOR WAVE HEIGHTS) | |
| 17.1.6 UNDER WATER | |
| CURRENTS | |
| 17.1.6.1 SAME AS 17.1.4.1 | |
| (SWEEL PERIODS ANALYTICS | |
| BUT FOR WATER CURRENTS) | |
| 17.1.7 SOLAR POWER OF BUOY | |
| 17.1.7.1 GAUGES SHOWING | |
| BATTERY | |
| 17.1.7.2 BATTERY | |
| 17.1.7.3 RETURN TO CHARGE | |

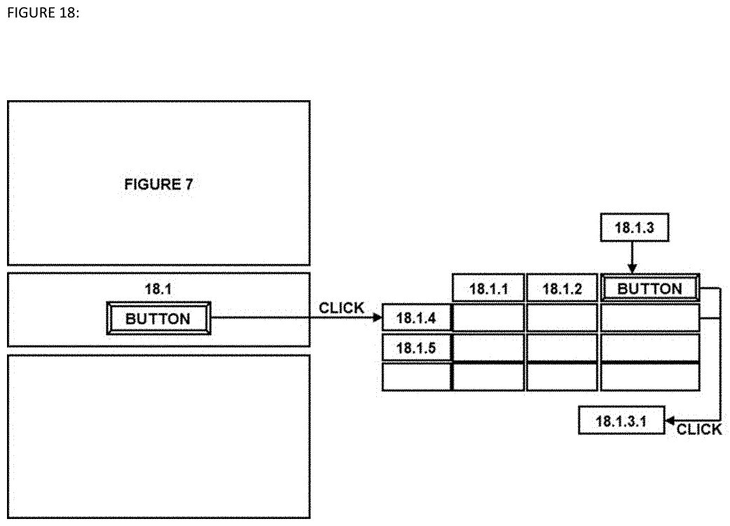

### Legend for FIG. 18:

7 REFERS TO SHIP SECTION OF THE FIG. 7 IN THIS DOCUMENT

18.1 WEIGHT METRICS

18.1.1 ACTUAL WEIGHT

18.1.2 PULLED WEIGHT

18.1.3 BUTTONS FOR AI ANALYTICS

18.1.3.1 AI BASED ANALYTICS SCREEN OPENS UP

18.1.4 SHIP 1

18.1.5 SHIP 2

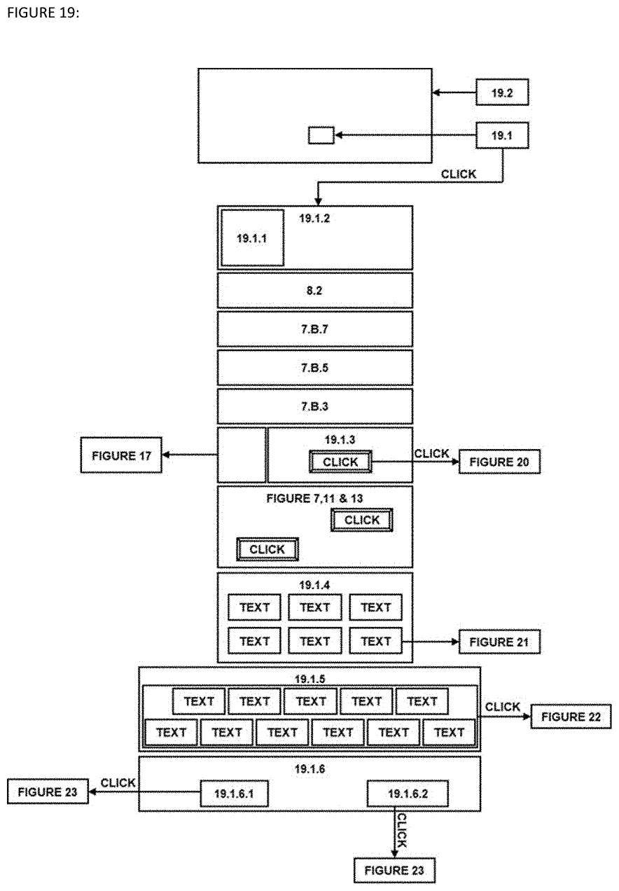

### Legend for FIG. 19:

19.1 HOLOGRAM OF PORT BERTH

19.1.1 ACTUAL PHOTO

19.1.2 DETAILS OF BERTH

8.2 CREW FROM FIG. 8 OF THIS DOCUMENT

7.B.7 REFERS TO SENSORS FROM FIG. 7 OF THIS DOCUMENT

7.B.5 REFERS TO VIDEO FEED FROM FIG. 7 OF THIS DOCUMENT

7.B.3 REFERS TO COMMUNICATION SECTION IN THE FIG. 7 OF THIS DOCUMENT

19.1.3 DOCKING SCHEDULE

17 REFERS TO FIG. 17 OF THE DOCUMENT

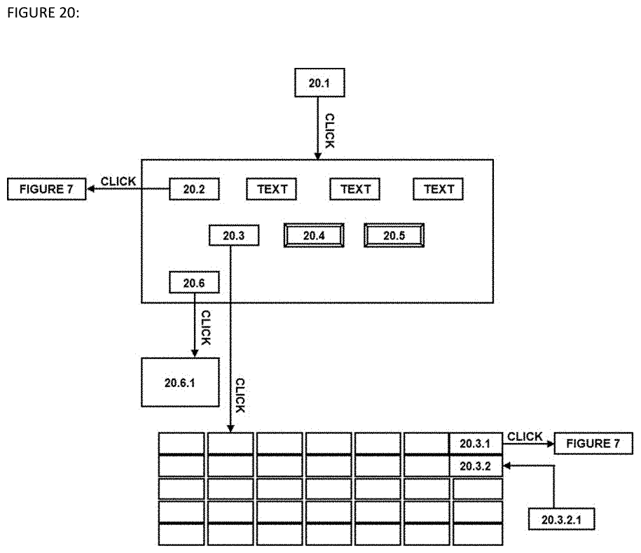

20 REFERS TO FIG. 20 OF THE DOCUMENT

7, 11 & 13 REFERS TO FIGS. 7, 11 & 13 OF THE MANUAL SECTIONS OF THESE FIGS.

19.1.4 CRANES SECTION

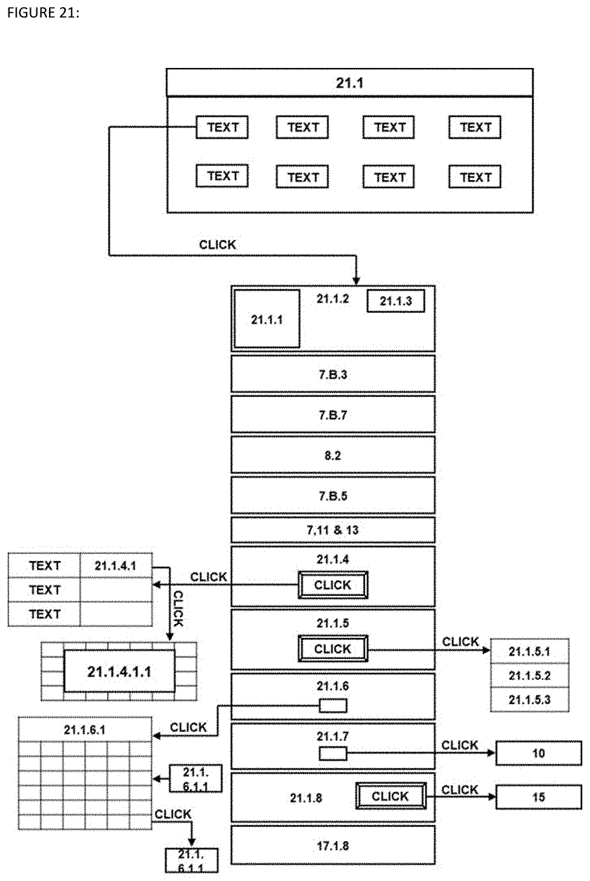

19.14.1 CLICKABLE BUTTON WHICH TAKES TO FIG. 21

19.1.5 CARGO CAPABILITY (MAPABLE FOR VARIOUS KINDS OF CARGOS)

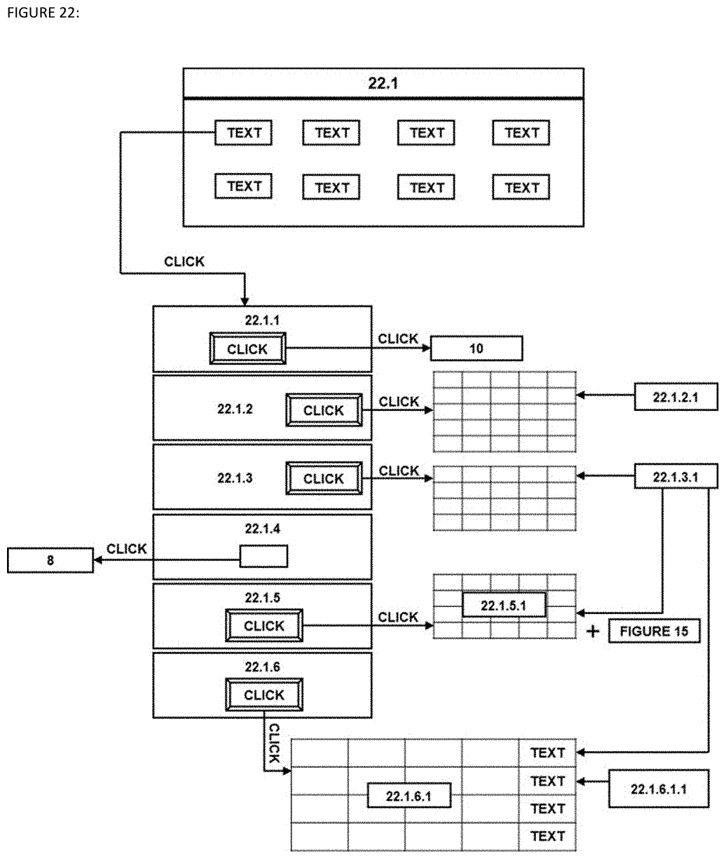

22 REFERS TO FIG. 22 OF THE FIG.

19.1.6 CONVEYNOR BELT

19.1.6.1 CONVEYNOR BELT CONTAINER

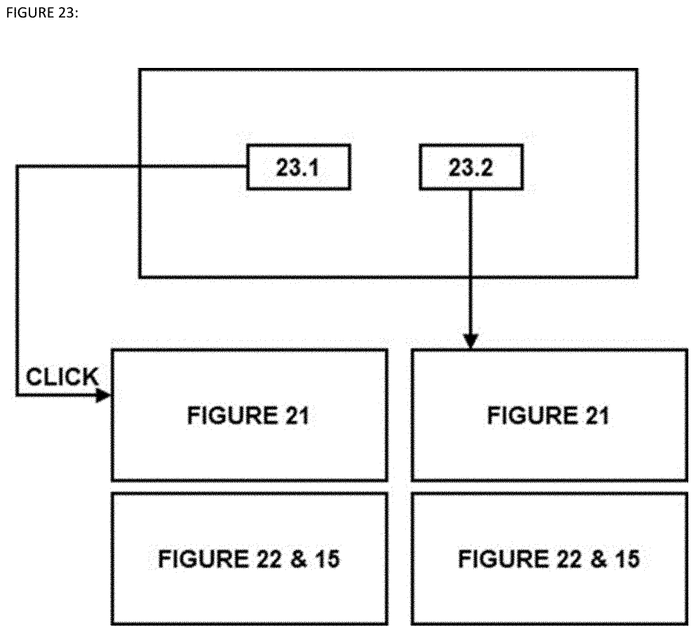

23 REFERS TO FIG. 23 OF THE DOCUMENT

19.1.6.2 CONVEYNOR BELT MATERIALS

23 REFERS TO FIG. 23 OF THE DOCUMENT

19.2 WATER HOLOGRAM

### Legend for FIG. 20:

20.1 DOCKING SCHEDULE SCREEN HOLOGRAM

20.2 MAPABLE BUTTON FOR SHIPS

7 REFERS TO FIG. 7 OF THE DOCUMENT

20.3 DAY WISE SCHEDULE

20.3.1 SHIP 1 DETAILS

7 REFERS TO FIG. 7 OF THE DOCUMENT

20.3.2 SHIP 2 DETAILS

20.3.2.1 DOCKING SCHEDULE SCREENS OPEN

20.4 MONTH WISE SCHEDULE

20.5 YEARLY SCHEDULE

20.6 AI BASED ANALYTICS

20.6.1 AI BASED ANALYTICS

### Legend for FIG. 21:

21.1 CRANES SCREEN; ALL CRANES ARE MAPABLE HERE

21.1.1 ACTUAL PHOTO

21.1.2 DETAILS OF CRANE

21.1.3 GPS COORDINATES OF CRANE

7.B.3 REFERS TO VIDEO FEED IN FIG. 7 OF THE DOCUMENT OF THIS DOCUMENT

7.B.7 REFERS TO COMMUNICATION FEED IN FIG. 7 OF THE DOCUMENT OF THIS DOCUMENT

8.2 REFERS TO CREW SECTION OF THE FIG. 8 OF THIS DOCUMENT

7.B.5 SENSORS FORM FIG. 7 OF THE DOCUMENT OF THIS DOCUMENT

7, 11 & 13 REFERS TO FIGS. 7, 11 & 13 OF THE MANUAL SECTIONS OF THESE FIGS.

21.1.4 CRANE SCHEDULES

21.1.4.1 DAY, MONTH AND YEAR WISE SCHEDULES

21.1.4.1.1 DETAILS OF EACH PORTION

21.1.5 LOAD DETAILS

21.1.5.1 LOAD SENSOR SCREEN

21.1.5.2 CURRENT LIFTING

21.1.5.3 WIGHT REMISSIBLE LIMIT

21.1.6 DISPATCH RATE

21.1.6.1 PARAMETERS

21.6.1.1 AI PARAMETERS SCREEN OPEN

21.1.7 CONTAINERS ON CRANE

10 REFERS TO FIG. 10 OF THE DOCUMENT (MODELLED FOR THIS SECTION)

21.1.8 DELIVERY SCHEDULES

15 REFERS TO FIG. 15 OF THE DOCUMENT

17.1.8 WARNING LIGHT SYSTEMS (REFER TO FIG. 17)

### Legend for FIG. 22:

22.1 CARGO CAPABILITY SCREEN

22.1.1 CARGO DETAILS

10 REFERS TO FIG. 10 OF THE DOCUMENT

22.1.2 DISPATCH CAPACITY

22.1.2.1 OPENS TO SCREEN SHOWING ALL PARAMETERS/INFORMATION/METRICS

22.1.3 DISPATCH METRICS

22.1.3.1 OPENS TO SCREEN SHOWING ALL PARAMETERS/INFORMATION/METRICS

22.1.5.1 OPENS TO SCREEN SHOWING ALL PARAMETERS/INFORMATION/METRICS

15 REFERS TO FIG. 15 OF THE DOCUMENT

22.1.6.1 TABLE SHOWING ALL PARAMETERS/INFORMATION/METRICS

22.1.6.1.1 OPENS TO SCREEN SHOWING ALL PARAMETERS/INFORMATION/METRICS

22.1.4 CREW HANDLING DISPATCH

8 REFERS TO FIG. 8 OF THE DOCUMENT

22.1.5 DISPATCH/DELIVERY SCHEDULES

22.1.5.1 OPENS TO SCREEN SHOWING ALL PARAMETERS/INFORMATION/METRICS

15 REFERS TO FIG. 15 OF THE DOCUMENT

22.1.6 DISPATCH ANALYTICS

22.1.6.1 TABLE SHOWING ALL PARAMETERS/INFORMATION/METRICS

22.1.6.1.1 OPENS TO SCREEN SHOWING ALL PARAMETERS/INFORMATION/METRICS

### Legend for FIG. 23:

23.1 CONVEYNOR BELT CONTAINERS

21 REFERS TO ALL FIGURE RELATED TO CONVEYNOR BELT 21 IN THE DOCUMENT

22 & 15 OPEN UPS CONVEYNOR BLET IN THE DOCUMENT

23.2 CONVEYNOR BELT MATERIALS

21 REFERS TO ALL FIGURE RELATED TO CONVEYNOR BELT 21 IN THE DOCUMENT

22 & 15 OPEN UPS CONVEYNOR BLET IN THE DOCUMENT

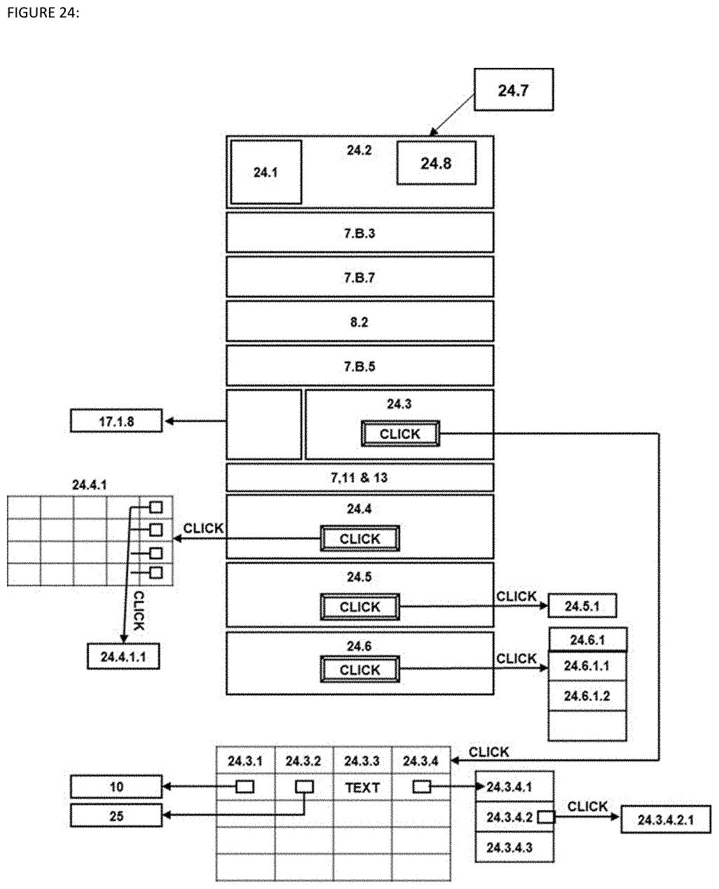

### Legend for FIG. 24:

| | |
|---|---|
| 24.1 PHOTO OF THE WEIGH | 24.3.4.2 DIGITAL SCANS |
| BRIDGES | 24.3.4.2.1 SCANS OF |
| 24.2 DETAILS OF WEIGH | RECORDS OPEN |
| BRIDGES | 24.3.4.3 ENTRY/EXIT |
| 7.B.3 REFERS TO VIDEO | REGISTER |
| FEED IN FIG. 7 OF THE | 7, 11 & 13 REFERS TO |
| DOCUMENT OF THIS | MANUAL SECTION OF |
| DOCUMENT | FIG. 7, 11 & 13 OF |
| 7.B.7 REFERS TO | THE DOCUMENT |
| COMMUNICATION FEED | 24.4 CUSTOM RECORDS |
| IN FIG. 7 OF THE DOCUMENT | 24.4.1 REFERS TO ITEMS |
| OF THIS DOCUMENT | 24.4.1.1 DIGITAL SCANS |
| 8.2 REFERS TO CREW | OF RECORDS |
| SECTION OF THE FIG. 8 OF | 24.5 AUTHORIZATION FOR |
| THIS DOCUMENT | WEIGH BRIDGE USE |
| 7.B.5 SENSORS FORM FIG. | 24.5.1 AUTHORIZATION |
| 7 OF THE DOCUMENT OF | RECORD OPEN |
| THIS DOCUMENT | 24.6 BILLING PORTAL |
| 24.3 WEIGH BRIDGE DATA | 24.6.1 POINT OF |
| 17.1.8 REFERS TO WARNING | SALES ACCESS |
| LIGHT SYSTEMS | 24.6.1.1 BILLING ERP |
| DIAGRAMS IN FIG. 17 OF | DETAILS |
| THIS DOCUMENT | 24.6.1.2 SCREENS + |
| 24.3.1 GOODS | LIVE BILLING |
| 10 REFERS TO FIG. 10 OF | 24.7 HOLOGRAM OF |
| THE DOCUMENT | WEIGH BRIDGE AND |
| 24.3.2 VEHICLE | SCREENS OPEN |
| 25 REFERS TO FIG. 25 OF | 24.8 GPS COORDINATES |
| THIS DOCUMENT | |
| 24.3.3 WEIGHT | |
| 24.3.4 VENDOR | |
| 24.3.4.1 VENDOR DETAILS | |

### Legend for FIG. 25:

25.1 REFERS TO HOLOGRAMIC IMAGE OF VEHICLE

25.1.1 PHOTO OF VEHICLE

25.1.2 DETAILS OF VEHICLE

25.1.3 GPS COORDINATES

8.2 REFERS TO CREW SECTION OF THE FIG. 8 OF THIS DOCUMENT

7.B.3 REFERS TO COMMUNICATION FEED IN FIG. 7 OF THE DOCUMENT OF THIS DOCUMENT

7.B.5 REFERS TO VIDEO FEED IN FIG. 7 OF THE DOCUMENT OF THIS DOCUMENT

7.B.7 SENSORS FORM FIG. 7 OF THE DOCUMENT OF THIS DOCUMENT

25.1.4 DELIVERY SCHEDULES/DISPATCH SCHEDULES

22 & 15 REFERS TO FIG. 22&15 FROM WHICH THE SCEENS WOULD BE TAKEN FROM THIS DOCUMENT

25.1.5 AUTHORIZATION RECORDS

24 REFERS TO AUTHORIZATION PART OF FIG. 24 ON WHICH THIS PART WILL BE MODELLED

25.1.6 AUTONOMOUS DRIVE

7.B.5 VIDEO FEED TAKEN FROM FIG. 7 IN THIS DOCUMENT

25.1.6.1 START BUTTON

25.1.6.2 CONTROL SCREEN

25.1.6.3 DESTINATION INPUT

25.1.6.4 MAP LOCATOR

25.1.6.5 CURRENT LOCATION

25.1.6.6 ESTIMATED TIME OF TRAVEL & ARRIVAL

7,11 & 13 REFERS TO MANUAL SECTION IN FIGS. 7,11 & 13

25.1.7 CUSTOM RECORDS

24 REFERS TO FIG. 24 IN THIS DOCUMENT

25.1.8 CARGO DETAILS

10 REFERS TO FIG. 10 IN THIS DOCUMENT

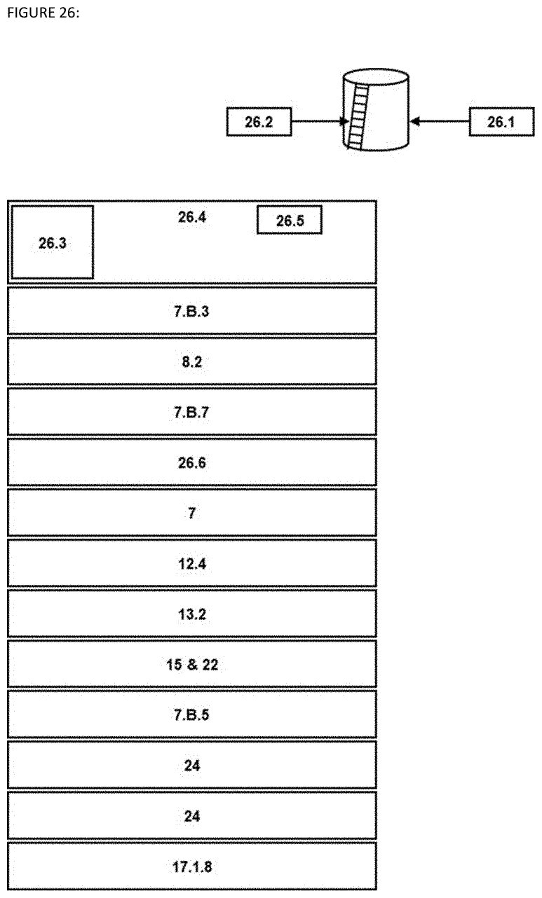

### Legend for FIG. 26:

26.1 STORAGE TANK HOLOGRAM

26.2 LADDERS

26.3 ACUTAL PHOTO OF STORAGE TANK

26.4 DETAILS OF STORAGE TANK

26.5 GPS COORDINATES

7.B.3 REFERS TO COMMUNICATION FEED IN FIG. 7 OF THE DOCUMENT OF THIS DOCUMENT

8.2 REFERS TO CREW SECTION OF THE FIG. 8 OF THIS DOCUMENT

7.B.7 SENSORS FORM FIG. 7 OF THE DOCUMENT OF THIS DOCUMENT

26.6 STORAGE TANK FIGURES HERE

7 REFERS TO FIG. 7 FROM WHICH MANUALS HAVE TO TAKEN AND MODELLED

12.4 REFERS TO STOCK TAKEN FROM FIG. 12 IN THIS DOCUMENT

13.2 REFERS TO MAINTANENCE RECORDS FROM FIG. 13 IN THIS DOCUMENT

15 & 22 ISSUING AND DELIVERIES SCHEDULE FROM FIG. 15& 22 OF THIS DOCUMENT

7.B.5 REFERS TO VIDEO FEED IN FIG. 7 OF THE DOCUMENT OF THIS DOCUMENT

24 REFERS TO CUSTOM RECORDS FROM FIG. 24 IN THIS DOCUMENT

24 REFERS TO AUTHORIZATION RECORDS FROM FIG. 24 IN THIS DOCUMENT

17.1.8 REFERS TO WARNING LIGHT SYSTEMS IN FIG. 17 IN THIS DOCUMENT

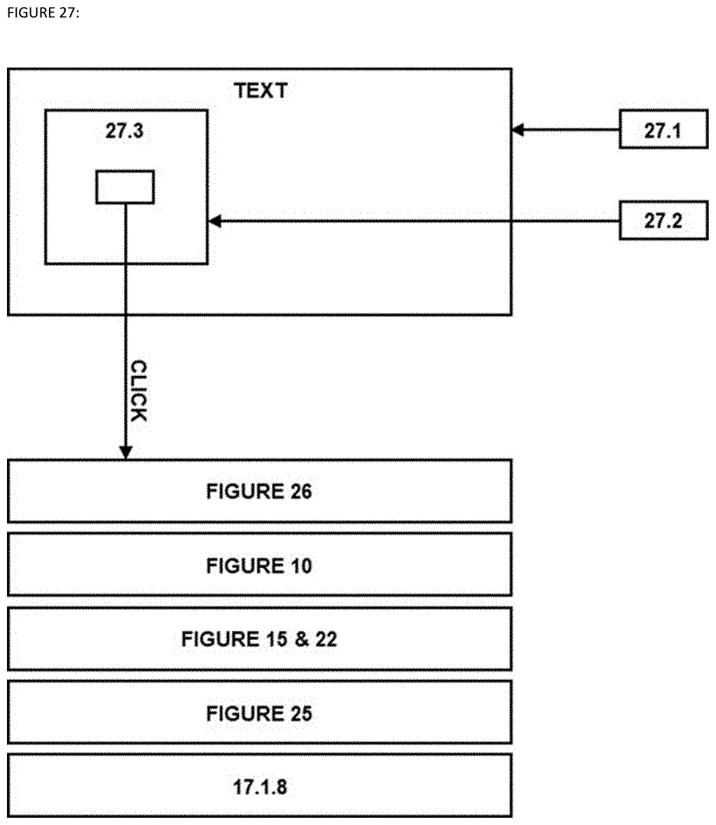

### Legend for FIG. 27:

27.1 HOLOGRAM OF PORT OPEN STORAGE-CARGO AREA IN AR-MR

27.2 HOLOGRAM OF PORT IN AR-MR

27.3 OPEN STORAGE AREA OF PORT

26 REFERS FIG. 26 IN THIS DOCUMENT MAPPED HERE

10 REFERS TO FIG. 10 OF THIS DOCUMENT

22 REFERS FIG. 22 OF THIS DOCUMENT

25 REFERS TO VEHICLE REGISTER FROM FIG. 25 IN THIS DOCUMENT

17.1.8 REFERS TO LIGHT WARNING SYSTEMS FROM FIG. 17 IN THIS DOCUMENT

NOTE: SAME ABOVE WILL BE FOR ALL CLOSED STORAGE AREA/WAREHOUSE/GODOWNS

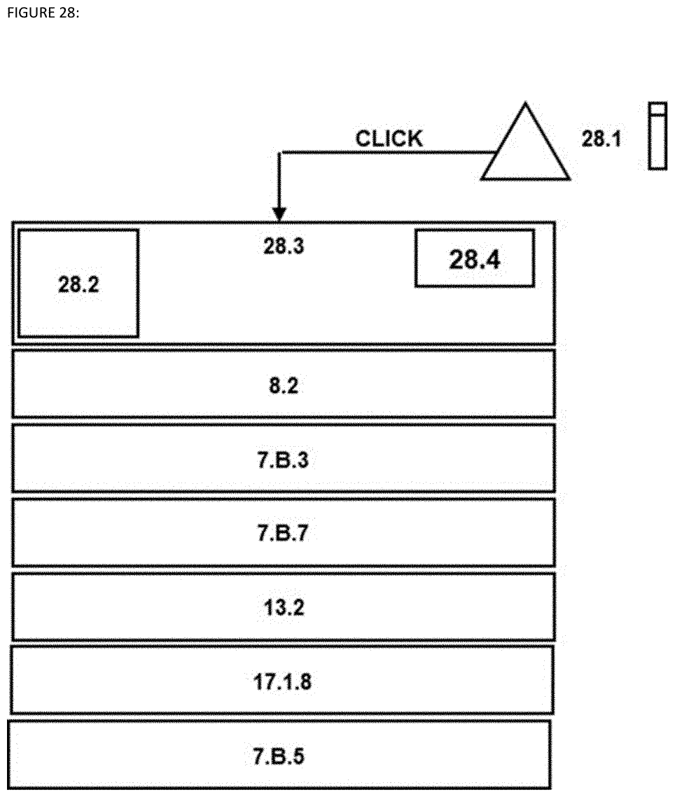

### Legend for FIG. 28:

28.1 HOLOGRAM OF LIGHT HOUSE

28.2 ACUTAL PHOTO

28.3 DETAILS

28.4 GPS COORDINATES

8.2 CREW DETAILS FROMFIGURE 8

7.B.3 COMMUNICATION FEED FROM FIG. 7 IN THIS DOCUMENT

7.B.7 SENSOR FEED FROM FIG. 7 IN THIS DOCUMENT

13.2 REFERS TO MAINTANENCE RECORDS IN FIG. 13

17.1.8 REFERS TO WARNING LIGHT SYSTEMS IN FIG. 17

7.B.5 REFERS TO VIDEO FEED IN THE FIG. 7

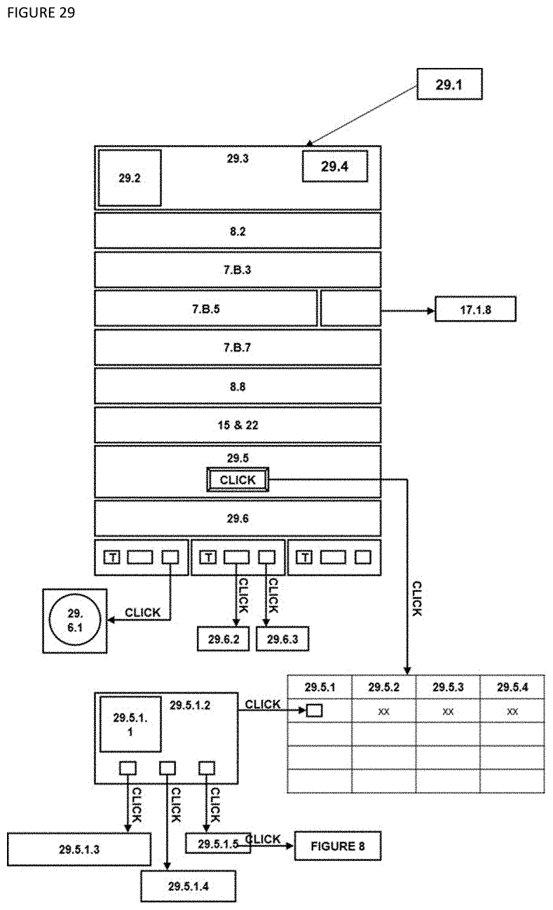

### Legend for FIG. 29:

29.1 REFERS TO HOLOGRAM OF SECURITY TOWER

29.2 REFERS TO ACTUAL PHOTO OF THE SECURITY TOWER

29.3 DETAILS ABOUT THE SECURITY TOWER

29.4 GPS COORDINATES

8.2 REFERS TO CREW SECTION OF THE FIG. 8 IN THIS DOCUMENT

7.B.3 REFERS TO VIDEO FEED SECTION OF THE FIG. 7 IN THIS DOCUMENT

7.B.5 REFERS TO COMMUNICATION SECTION OF THE FIG. 7 IN THIS DOCUMENT

17.1.8 REFERS TO WARNING LIGHT SYSTEM SECTION OF THE FIG. 17 IN THIS DOCUMENT

7.B.7 REFERS TO SENSORS IN THE FIG. 7 OF THIS DOCUMENT

8.8 REFERS TO DUTY ROSTER IN THE FIG. 8 OF THIS DOCUMENT

15 & 22 REFERS TO DELIVERIES SCHEDULE FROM FIGS. 15 & 22 IN THIS DOCUMENT

29.5 AMMUNATION STOCK

29.5.1 ITEM

29.5.1.1 ACUTAL PHOTO

29.5.1.2 DETAILS

29.5.1.3 DIGITAL SCANS OF RECORDS OF ITEM

29.5.1.4 ITEM LOCATOR SENSOR

29.5.1.5 ITEM ISSUED TO

8 REFERS TO CREW SECTION OF THE FIG. 8 IN THIS DOCUMENT

29.5.2 ISSUED

29.5.3 USED

29.5.4 BALANCE

29.6 TARGET SYSTEMS

29.6.1 TARGET SCREEN

29.6.2 LOAD

29.6.3 FIRE

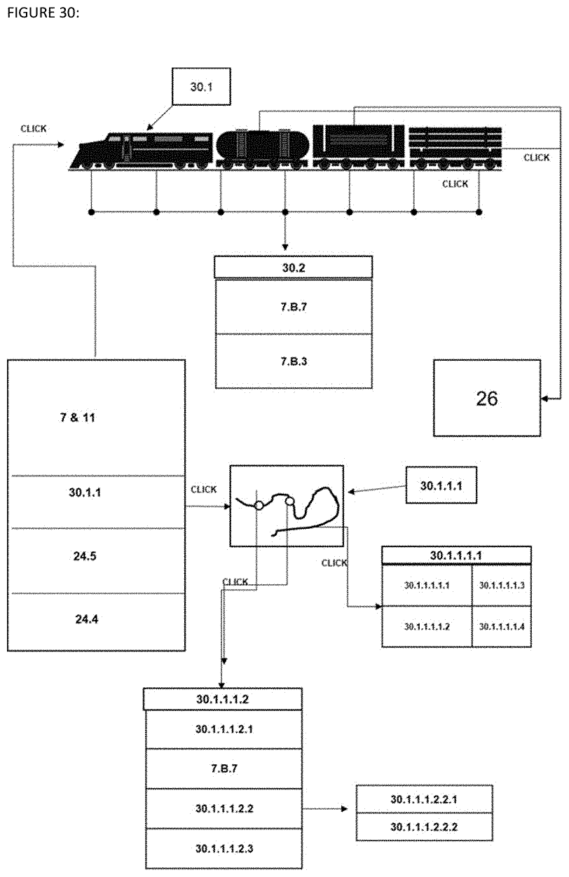

### Legend for FIG. 30:

30.1 REFERS TO HOLOGRAM OF TRAIN

26 REFERS TO FIG. 26 OF THIS DOCUMENT

7 & 11 REFES TO FIG. 7&11 OF THIS DOCUMENT MODELLED FOR THIS SECTION

30.1.1 REFERS TO ROUTE MAP

30.1.1.1 HOLOGRAM OF ROUTE

30.1.1.1.1 ROUTE SCREEN OPENS UP

30.1.1.1.1.1 ESTIMATED TIME OF ARRIVAL

30.1.1.1.1.2 DISTANCE TRAVELLED

30.1.1.1.1.3 ROUTE STOPPAGES

30.1.1.1.1.4 OTHER INFORMATION CAN BE MAPPED

30.1.1.1.2 TRAIN STOPPING POINT

30.1.1.1.2.1 ACTUAL PHOTO

7.B.7 COMMUNICATION SYSTEM FROM FIG. 7 OF THIS DIAGARM

30.1.1.1.2.2 MAP

30.1.1.1.2.2.1 SATTELITE IMAGE

30.1.1.1.2.2.2 GOOGLE MAP

30.1.1.1.2.3 GPS COORDINATES

24.5 AUTHORIZATION RECORDS FROM FIG. 24 OF THIS DOCUMENT

24.4 CUSTOM RECORDS FROM FIG. 24 OF THIS DOCUMENT

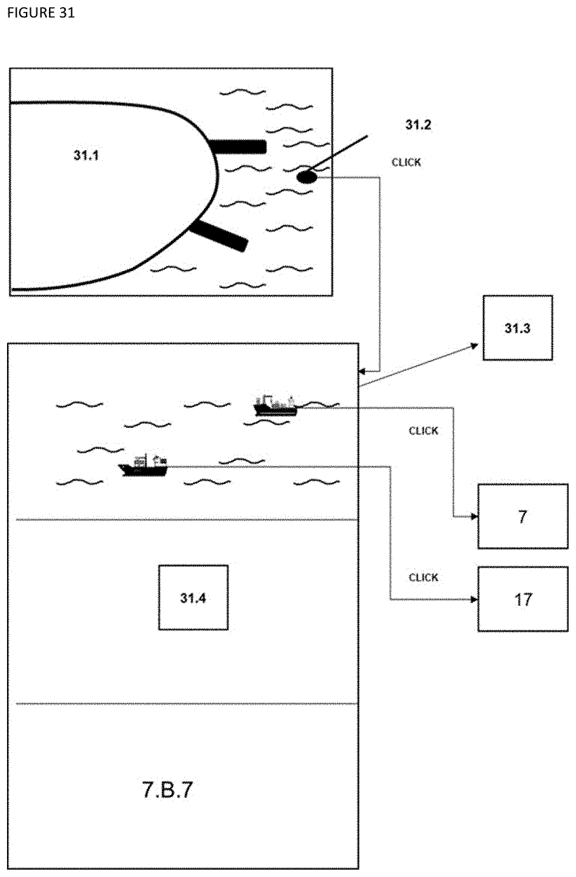

### Legend for FIG. 31

31.1 PORT

31.2 AN ICON IN HOLOGRAM REPRESENTING “PORT CHANNEL”

31.3 RADAR FEED OF CHANNEL/OUTER SEA

7 REFERS FIG. 7 OF THIS DOCUMENT WHICH IS MAPPED FOR ALL SHIPS

17 REFERS TO FIG. 17 OF THIS DOCUMENT WHICH IS MAPPED FOR ALL BUOYS

31.4 NAVIGATION FEED OF CHANNEL

7.B.7 SENSORS FORM FIG. 7 MAPPED FOR THIS FIGURE

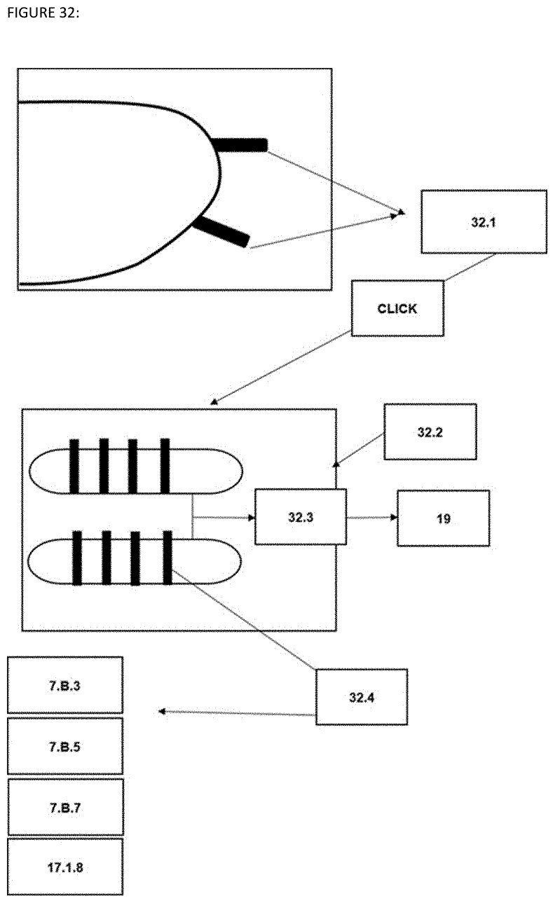

### Legend for FIG. 32:

32.1 HOLOGRAM OF JETTY

32.2 SCREEN OPENS IN AR-MR

32.3 BERTH

19 REFERS TO FIG. 19 OF THE DOCUMENT MAPPED FOR THIS PART

32.4 LAMPPOST

7.B.3 REFERS TO VIDEO FEED SECTION OF THE FIG. 7 IN THIS DOCUMENT

7.B.5 REFERS TO COMMUNICATION SECTION OF THE FIG. 7 IN THIS DOCUMENT

7.B.7 REFERS TO SENSORS IN THE FIG. 7 OF THIS DOCUMENT

17.1.8 REFERS TO WARNING LIGHT SYSTEM SECTION OF THE FIG. 17 IN THIS DOCUMENT

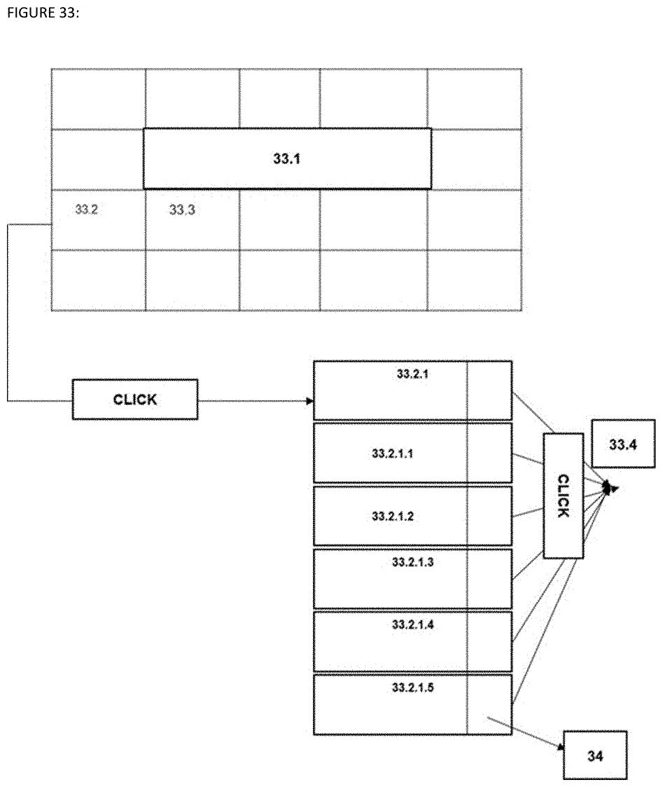

### Legend for FIG. 33:

33.1 REFERS TO FIG. 2 WHICH CAN BE MODIFIED AS PER CHANGES

33.2 SHIP AI

33.2.1 ALL ASSESTS

33.2.1.1 TO 33.2.1.5 MAPABLE FOR VARIOUS SHIPS

33.4 BUTTON TO CLICK FOR EACH ASSET TO GO TO ITS AI-BASED ANALYTICS

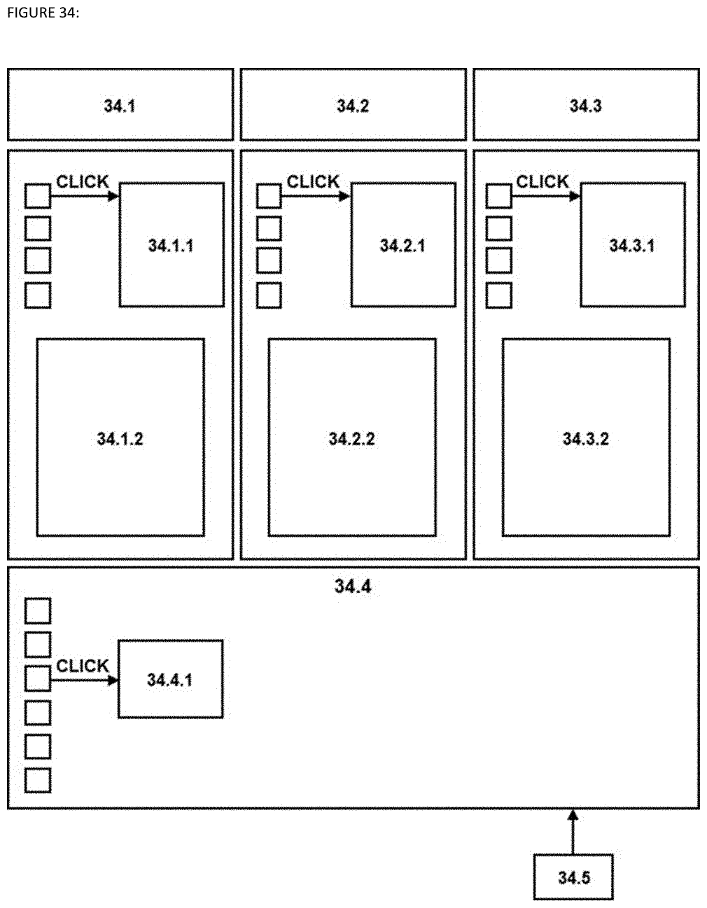

34 REFERS TO FIG. 34 OF THIS DOCUMENT

33.3 PORT AI

### Legend for FIG. 34:

34.1 DESCRIPTIVE ANALYTICS AND OPERATIONS

34.1.1 SCREENS OPEN FOR EACH PARAMETER WITH ALL KINDS OF ANALYTICS & OPERATIONS

34.1.2 BUTTONS MAPABLE FOR ALL POSSIBLE AND REQUIRED PARAMETERS LISTED

34.2 PREDICTIVE ANALYTICS AND OPERATIONS

34.2.1 SCREENS OPEN FOR EACH PARAMETER WITH ALL KINDS OF ANALYTICS & OPERATIONS

34.2.2 BUTTONS MAPABLE FOR ALL POSSIBLE AND REQUIRED PARAMETERS LISTED

34.3 PRESECRIPTIVE ANALYTICS AND OPERATIONS

34.3.1 SCREENS OPEN FOR EACH PARAMETER WITH ALL KINDS OF ANALYTICS & OPERATION

34.3.2 BUTTONS MAPABLE FOR ALL POSSIBLE AND REQUIRED PARAMETERS LISTED

34.4 AI COGNITIVE ANALYTICS & OPERATIONS (WARNING: AUTONOMY GIVEN TO Al)

34.4.1 SCREENS OPEN ON CLICK

34.5 HOLOGRAM BOX IN AR-MR

NOTE: SAME HAS TO BE MADE FOR ALL NAUTICA BOXES of ALL DIGITAL ASSETS IN NAUTICA CENTRAL COMMAND

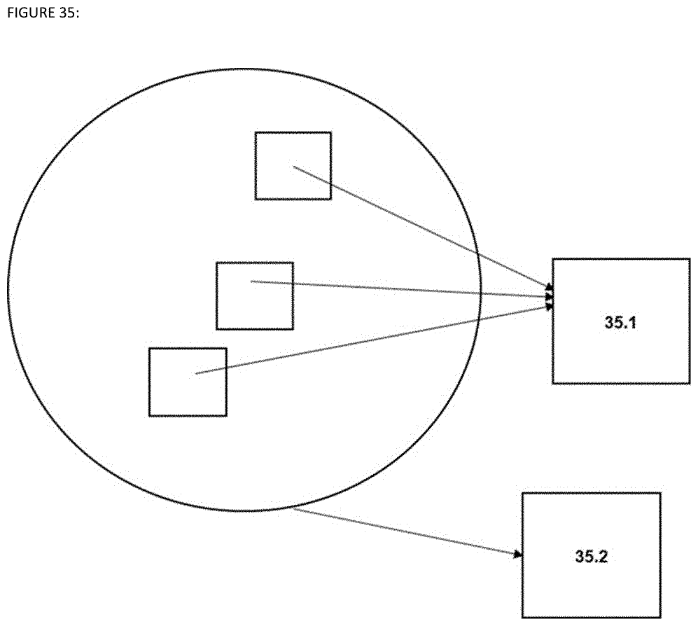

### Legend for FIG. 35

35.1 HOLOGRAM OF ALL ASSETS WHICH CAN BE CLICKED TO OPEN THEIR SCREENS

35.2 HOLOGRAM OF ROTATING EARTH

NOTES: ON CLICKING EARTH BUTTON IN NAUTICA CENTAL COMMAND, A 3D HOLOGRAM OF EARTH APPEARS IN AR-MR SHOWING ALL ASSETS PLUGGED INTO NAUTICA.

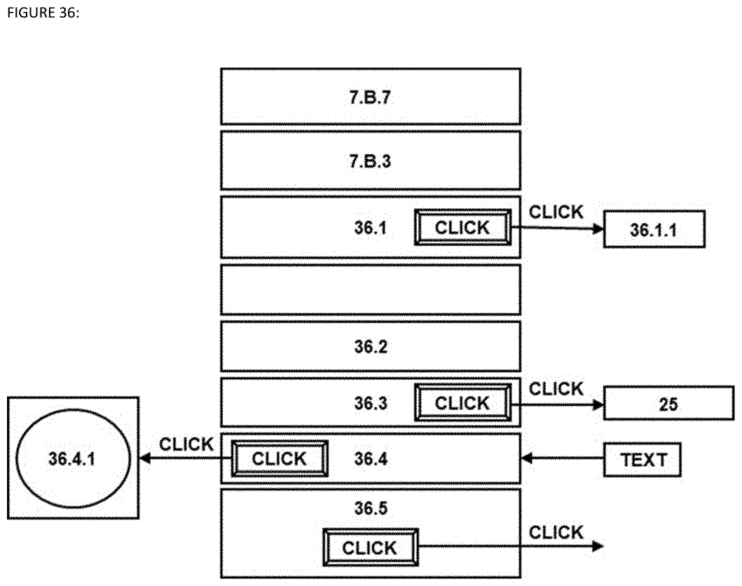

### Legend for FIG. 36:

7.B.7 REFERS TO SENSORS FEED FROM FIG. 7 OF THIS DOCUMENT

7.B.3 REFERS TO VIDEO FEED FROM FIG. 7 OF THIS DOCUMENT

36.1 LIDAR FEED

36.1.1 LIDAR SCREENS AND FEED OPEN

36.2 SOLAR POWER OF DRONE

36.3 AUTONOMOUS FLIGHT

36.3.1 MAPPED AS PER AUTONOMOUS DRIVE OF FIG. 25 OF THIS DOCUMENT

36.4 RADAR FEED

36.4.1 RADAR SCREENS OPEN UP

36.5 SONAR FEED

36.5.1 SONAR SCREENS & FEED OPENS UP

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. Although any methods similar or equivalent to those described herein can be used in the practice or testing of embodiments of the present disclosure, the exemplary, methods are now described.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

As shown in FIG. 1, to Start NAUTICA, 1.2 USER (HUMAN/ALIEN/ROBOT) can:
A. USER (HUMAN/ALIEN/ROBOT) Wear SMART Glass/Eyewear (1.1) with Augmented Reality (AR)—Mixed Reality (MR) holographic projection capability or
B. 1.2 USER (HUMAN/ALIEN/ROBOT) starts device with Augmented Reality (AR)—Mixed Reality (MR) holographic projection capability

Post Starting NAUTICA, 1.2 USER (HUMAN/ALIEN/ROBOT) sees 2.3 HOLOGRAM BOX IN AR-MR with 2.1

NAUTICA CENTRAL COMMAND and 2.2 NAUTICA ARTIFICIAL INTELLIGENCE COMMAND. 1.3.2 REFERS TO CLICKABLE BUTTON OR “VOICE COMMAND ACTIVATED” BUTTON IN FIG. 1 OF THE DOCUMENT. The user can also see the physical environment around him in AR-MR. All buttons are clickable in Central command: 2.1.1 EVERY ROW AND COLUMN IS CLICKABLE OF THE CENTRAL COMMAND and 2.1.1 EVERY ROW AND COLUMN IS CLICKABLE OF THE NAUTICA ARTIFICIAL INTELLIGENCE

From FIG. 2, User can select any button. For Example, User selects “Ships” button (3.1 REFERS TO SHIPS BASED ON SELECTION IN 2.1) and comes to FIG. 3 (3.2 HOLOGRAM BOX IN AR-MR). User can select any country (3.1.1 ALL BUTTONS ARE CLIKABLE BUTTON FOR ALL COUNTRIES OF THE WORLD) or even combine all countries by selecting the “World” Button (3.3 BUTTON FOR COMBINING ALL COUNTRIES OF THE WORLD. All screens of NAUTICA are 3.2 HOLOGRAM BOX IN AR-MR and in Mobile, IOs, Android, tablets versions.

Upon selecting the country in FIG. 3, 4.1 HOLOGRAMIC IMAGE OF COUNTRY OPENS IN AR-MR as shown in FIG. 4: 4.1.1 HOLOGRAM OF THE COUNTRY SELECTED. A detailed illustration of FIG. 4 is shown in FIG. 5.

In FIG. 5, the entire selected country's map is shown as a HOLOGRAM MAP OF SELECTED COUNTRY as a 5.1 “IN AIR VIEW” and is broken by NAUTICA into; 5.7 HOLOGRAM OF ALL SHIPS (Ship is an example of a Digital Asset). APPEAR IN BOTH NATIONAL AND INTERNATIONAL WATERS AROUND THAT COUNTRY, 5.8 A COLOURED LINE IN THE HOLOGRAM ALSO SHOWS MARITIME BOUNDARY AROUND THAT COUNTRY, 5.9 RIVERS ARE ALSO SHOWN IN THE HOLOGRAM, 5.10 SHIPS AND BOATS IN THE RIVER. The USER (HUMAN/ALIEN/ROBOT) also has the option buttons of 5.3 BACK BUTTON, 5.4 NAUTICA CENTRAL COMMAND BUTTON, 5.5 ALL COUNTRIES BUTTON. All the Alphabets and Numbers in all screens of NAUTICA are also as HOLOGRAM ALPHABETS AND NUMBER IN AR AND MR. User can click on any assets or boundaries on the hologram and it opens to further screens in AR-MR. NOTE: ALL COUNTRIES WILL HAVE TO BE MADE IN NAUTICA LIKE ABOVE ILLUSTRATION.

FIG. 6 is an “On ground” hologram projection (6.3 HOLOGRAM PROJECTION OF INDIA ON GROUND) of FIG. 5. All holograms appear such as 6.4 HOLOGRAMIC IMAGE OF RIVER, 6.5 HOLOGRAMIC IMAGE OF SHIPS, 6.6 INTERNATIONAL MARITIME BOUNDARY HOLOGRAM. NOTE: ALL MARITIME SHIPPING, WATERWAYS, PORT MACHINERY, EQUIPMENTS, BUILDING, WORKERS ARE ALL ASSETS. NAUTICA IS CREATING A “DIGITAL TWIN” OF THAT “PHYSICAL ASSET”. THE DIGITAL TWIN IS A “LIVE” REPLICATION OF THAT PHYSICAL ASSET. The User can also view previous Satellite Images of any chosen sector using a SATELLITE IMAGE button or live satellite images button of any chosen sector.

As an example, when User clicks on “Ship Asset” (7.A.2 SHIP HOLOGRAM), further holographic screens open as shown in 7B REFERS TO FIG. 7B IN THE DOCUMENT. The holographic screens open for 7.B.1 ACTUAL PHOTO OF ASSET, 7.B.2 DETAILS OF THE SHIP, 7.B.3 COMMUNICATION SECTION which further opens screens of 7.6.3.1 WHATSAPP leading to 7.6.3.1.1 TEXT SCREENS, 7.13.3.2 INTERNET SEARCH leading to 7.6.3.2.1 GOOGLE ICON, 7.6.3.2.1.1 GOOLE SEARCH, 7.6.3.3 SPEAKER, 7.6.3.4 MUTE, 7.6.3.5 TRANSLATE with screen of 7.6.3.5.1 CLICK ON ANY LANGAUGE AND AI (ARTIFICIAL INTELLIGENCE LANGUAGE TRANSLATOR) CONVERTS NAUTICA TO THAT LANGAUGE, 7.6.3.6 EMAIL, 7.6.3.7 SKYPE LEADING TO SCREENS OF 7.6.3.7.1 SKYPE FEED OPENS, 7.6.3.8 PHONE LEADING TO SCREENS OF 7.6.3.8.1 DIALPAD FOR PHONE, 7.B.4 CREW DETAILS (REFERS TO FIG. 8 IN THE DOCUMENT), 7.B.5 VIDEO FEED leading to screens of 7.6.5.1 NORMAL VISION, 7.6.5.2 NIGHT VISION, 7.6.5.3 THERMAL VISION, 7.6.5.4 EXPANDS EACH FEED (VIDEO FEED ALSO HAS FACE+ARM& AMMUNITION DETECTION FOR PASSANGERS & PIRATES). User can also click and open screens of live 7.B.6 GPS COORDINATES (CHANGES FOR EVERY HOLOGRAM OF EACH ASSET AS PER LIVE LOCATION). User can also click to open screens of 7.6.6.1 ESTIMATED TIME OF ARRIVAL, 7.6.6.2 DEPARTURE TIME. User can also click on Sensor feeds to open further screens such examples as 7.B.7 SENSORS OF THE SHIP leading to 7.6.7.1 FUEL, 7.6.7.2 NAUTICAL MILES, 7.6.7.3 HUMIDITY, 7.13.7.4 WIND, 7.13.7.5 DEPTH, 7.13.7.6 WAVES, 7.13.7.7 AIR, 7.13.7.8 TEMPARTURE, 7.13.7.9 SPEED, 7.6.7.10 POWER, 7.6.7.11 ALLTITUDE, 7.6.7.12 SEA LEVEL.7.6.7.13 EACH OF THE BUTTONS FROM 7.6.7.1 TO 7.6.7.12 IS CLICKABLE AND OPENS A SCREEN WHICH HAS AI BASED ANALYTICS OF EACH SENSOR. User can also click to open further screens of 7.B.8 CARGO DETAILS leading to screens of 7.6.8.1 PASSENGERS (REFERS TO FIG. 9 IN THE DOCUMENT), 7.6.8.2 GOODS (REFERS TO FIG. 10 IN THE DOCUMENT), 7.B.9 AREAS OF SHIPS leading to further screens of 7.6.9.1 SHIP BRIDGE (REFERS TO FIG. 16 IN THE DOCUMENT), 7.6.9.2 CANTEEN, 7.8.9.3 LIVING QUARTER (REFERS TO FIG. 12 IN THE DOCUMENT), 7.8.9.4 ENGINE ROOM (REFERS TO FIG. 11 IN THE DOCUMENT), 7.8.9.5 MAINTAINENCE, 7.8.9.6 PERSONAL LOCATOR leading into 7.8.9.6.1 SCREEN OPENS UP WITH SHOWING EACH PERSONAL ON THE SHIP, 7.8.9.7 LICENSES, 7.8.9.8 CANTEEN and all other parameters of the digital asset (7.8.9.9 OTHERS). User can also click to open further screens of 7.6.10 MANUALS leading to screens of 7.6.10.1 OPERATION MANUALS, 7.6.10.2 EMERGENCY MANUALS, 7.6.10.3 BLUEPRINTS OF SHIP, 7.6.10.4 DIGITAL SCANS OF MANUAL OPENS. User can also click to open screens of 7.6.11 DUTY ROSTERS (REFERS TO FIG. 8 OF THE DOCUMENT), 7.6.12 COMMUNICATION SECTIONS (WITH OTHER PARTIES) which leads to further screens of 7.6.12.1 NAVY, 7.6.12.2 COAST GUARD, 7.6.12.3 MEDICAL, 7.6.12.4 POLICE, 7.6.12.5 IMMIGRATION. User can also click to open 7.8.9.6.1 SCREEN OPENS UP WITH SHOWING EACH PERSONNEL/CREW LOCATION ON THE SHIP. NOTE: EVERY SINGLE ASSETS HOLOGRAM IS ALSO CLICKABLE. ALL AND EVERY TYPE OF MARITIME, PORT ASSETS OF EVERY COUNTRY IS AVAILABE IN NAUTICA AS A DIGITAL ASSET. EACH AND ALL DIGITAL ASSETS ARE REPRESENTED WITH A SPECIFIC HOLOGRAM OF THAT ASSET IN NAUTICA. OTHER EXAMPLES OF ASSETS OF ARE (but not limited to): Tug boats, Submarines, Ships, boats, ferries, shipping containers, shipping ports, port berths, buoys, cranes, drones(including sea drones and land drones), Storage tanks, port control centre, pipelines, lighthouse, port distribution area, port entry-exit points, train, open storage areas, port water channel, storage warehouses, Port engineering cargo belt, weigh bridges, jetty, vehicles (cars, jeeps, Trucks, Bike etc), security/guard towers and personnel. More assets can be added to view on more screens.

FIG. 8 depicts the hologram screens of a Personnel/crew member. User selects the crew member and screes open for 8.1 ACTUAL PHOTO OF CREW MEMBER, 8.2 PERSONAL DETAILS OF CREW. User can also click to open communication section (7.B.3 REFERS TO COMMUNICATION SECTION OF FIG. 7), 8.3 VIDEO FEED which leads to further screens of 8.3.1 NORMAL VIEW, 8.3.2 THERMAL VIEW 8.3.3 NIGHT VISION VIEW 8.3.3.1 VIDEO FEED SCREEN (AI-ARTIFICIAL INTELLIGENCE BASED FACE+ARMS/AMMUNITION LOCATOR. User can also click to open screens for 8.4 VITALS which further opens screens for 8.4.1 DETAILED VITALS OF CREW MEMBER and 8.4.1.1 DETAILED AI-ARTIFICIAL INTELLIGENCE ANALYTICS SCREEN GIVING WEEKLY/MONTHLY AND HOUR WISE DATA. User can click to view live 8.5 GPS COORDINATES. User can also click to open screens of 8.6 RANKING OFFICER DETAILS and communicate with ranking officer (7.B.3 REFERS TO COMMUNICATION SECTION OF FIG. 7. User can also click to open screens of 8.7 RECORDS which open further screens of 8.7.1 OPENS UP RECORD OF THE CREW MEMBER leading to 8.7.1.1 DIGITAL SCREEN OPENS UP, 8.8 DUTY ROSTER leading to further screens of 8.8.1 DAY WISE/MONTH WISE DUTY SCHEDULE& ROSTERS, 8.8.1.1 ATTENDANCE RECORDS OPEN, 8.8.1.1.1 DIGITAL SCANS OF ATTENDANCE RECORD OPENS. User can also access sensor feed (7.B.7 SENSORS SECREEN FROM FIG. 7 OF THIS DOCUMENT) and 8.9 KEY SPECIALITIES OF CREW MEMBER. More parameters can be added to view on more screens.

FIG. 9 depicts screens for Ship passengers. User click to open screens of 9.1 SHIP PASSENGER DISTRIBUTION which leads to further screens of 9.1.1 BLUEPRINT OF THE SHIP and 9.1.2 EACH PASSENGER SHOWN. User can click to open screens of 9.2 SHIP PASSENGER LIST which opens further screens of 9.2.1 DETAILS OF PASSENGER leading to screens of 9.2.1.1 NAME, 9.2.1.2 AGE, 9.2.1.3 NATIONALITY, 9.2.1.4 PASSENGER RECORDS SCAN, 9.2.1.4.1 DIGITAL SCANS OF PASSENGER RECORDS OPEN UP. User can also click to locate every single person on the ship using 9.3 SHIP PASSENGER LOCATOR. Every passenger on a ship is given 9.3.1 EACH OF THE PASSENGER GIVEN A WRIST BAND WITH GPS LOCATOR+RFID TAG which can be located using screens of 9.3.1.1 BLUE PRINT OF THE SHIP, 9.3.1.2 GPS LOCATION OF THE PASSENGER, CLICKING ON IT GIVES DETAILS OF THAT PASSENGER. User can also click to open screens of 9.4 SHIP PASSENGER ANALYTICS which opens screens of 9.4.1 AI BASED EACH PASSENGER ANALYTICS (ALL TYPES) leading to screens of 9.4.1.1 HER/HIS SPENDING HABITS, 9.4.1.2 PASSENGER FOOD ORDERS, 9.4.1.3 AREAS OF SHIP VISITED etc. More parameters can be added to view on more screens.

FIG. 10 depicts The Cargo Screens. User clicks 7.6.8.2 GOODS to open screens of 10.1 CARGO LIST which further opens 10.1.1 CARGO DETAILS leading to screens of 10.1.1.1 CARGO DETAILS TABLE and 10.1.1.1.1 ACTUAL PHOTOS. User can also access sensor feed of each cargo container (7.B.7 REFERS TO SENSOR FEED FROM FIG. 7 IN THE DOCUMENT) and video feed of each cargo container (7.B.5 REFERS TO VIDEO FEED FROM FIG. 7 IN THE DOCUMENT). User can also click to open screens of 10.1.1.1.2 WEIGHT leading to screens of 10.1.1.1.2.1 WEIGHT IN TONS, 10.1.1.1.3 CUSTOM RECORDS leading to screens of 10.1.1.1.3.1 DIGITAL SCANS. User can also click to open 10.2 CARGO BLUEPRINT leading to further screens of live 10.2.1 GPS LOCATION OF CARGO CONTAINER/GOOD, 10.2.2 SHIP BLUE PRINT. User can also click to open screens of 10.3 CARGO LOADING/UNLOADING leading to further screens of 10.3.1 LOADING/UNLOADING SCHEDULES, 10.3.2 LOADING/UNLOADING PERFORMANCE which further opens screens of 10.3.2.1 LOADING TIME METRICS+AI ANALYTICS (SCREENS FOR EACH CARGO CONTAINER/GOODS. Examples of loading metrics are: loading time, loaded by, loaded on etc.

FIG. 11 depicts the illustration of an “Engine Room”. User click on 7.8.9.4 ENGINE ROOM and opens holographic screens (11.1.1 OPENS TO HOLOGRAMIC SCREEN) of 11.1.1.1 ENGINE PISTON, 11.1.1.2 ENGINE VALVE, 11.1.1.3 ENGINE CHAMBER, 11.1.1.4 ALL ENGINE PARTS/SECTIONS LISTED. User can select any part of the engine and it opens further screens of that selected part of the engine like 11.1.1.4.1 STATUS SENSORS (ALL TYPES) and its screens 11.1.1.4.1.1 GAUGE with each sensor's own Artificial intelligence-based analytics (11.1.1.4.1.1.1 SCREEN OF THE SENSOR WITH ANALYTICS OPEN), 11.1.1.4.1.2 TEMPRATURE, 11.1.1.4.1.3 HUMIDITY. User can also click to open further screens of 11.1.1.4.2 DETAILS OF ENGINE PART, 11.1.1.4.3 SERVICE/MAITAINANCE RECORDS (REFERS TO FIG. 13 OF THE DOCUMENT), 11.1.1.4.4 MANUALS OF THE ENGINE (7.B.10 REFERS TO MANUAL SECTION OF THE FIG. 7). User can also communicate with that engine part manufacturer (7.B.3 REFERS TO COMMUNICATION SECTION OF THE FIG. 7). User can also open further screens of each engine part's Ai based analytics 11.1.1.4.5 AI BASED ANALYTICS OF ENGINE PART which opens further screens or 11.1.1.4.5.1 PARAMETERS TO BE MEASURED FOR ENGINE PARTS PERFORMANCE and 11.1.1.4.5.1.1 GRAPHICS, VISUAL DIAGRMAS AND AI ANALYTICS. Similarly, every part of a Digital Asset will open in holographic screens of that part as FIG. 11.

FIG. 12 depicts the Holographic screens of a 7.8.9.3 LIVING QUARTER. User click and opens screens of 12.1 ACTUAL PHOTO, Video feed (7.B.5 REFERS TO VIDEO FEED SECTION IN THE FIG. 7 OF THIS DOCUMENT), Communication section (7.B.3 REFERS TO COMMUNICATION SECTION IN THE FIG. 7 OF THIS DOCUMENT). User can also click to open screes of 12.2 LIVING QUARTERS ALLOCATION which opens further screens of 12.2.1 TABLE FOR DETAILS ABOUT QUARTERS (REFERS TO FIG. 8 OF THE DOCUMENT, Model it like, Bed 1: Name of Occupant which links to FIG. 8). User can click to open further screens of 12.3 DUTY ROSTERS FOR LIVING QUARTER (REFERS TO FIG. 8 OF THE DOCUMENT), 12.4 STOCK FOR LIVING QUARTERS which leads to further screens of 12.4.1 DETAILS OF ITEM USED FOR LIVING QUARTERS leading to screens of 12.4.1.1 ITEMS, 12.4.1.2 ISSUED TO AND BY WHOM, 12.4.1.3 USED, 12.4.1.4 BALANCE which further leads to screens of 12.4.1.4.1 DETAILS 12.4.1.4.2 RECORDS, 12.4.1.4.2.1 DIGITAL SCANS OF ITEM SPECIFICATION, 12.4.1.4.2.2 DIGITAL SCAN OF ITEMS PROCUREMENT, 12.4.1.4.3 BUTTON FOR AI, 12.4.1.4.3.1 AI BASED ANALYTICS SCREENS, 7.B.10 REFERS TO MANUAL SECTION IN FIG. 7 (MODELLED FOR THIS SECTION).

FIG. 13 depicts the holographic screens of 7.8.9.5 MAINTAINENCE. User click to open further screens of 13.1 CURRENT TASKS leading to screens of 13.1.1 TASK which further opens to 13.1.1.1 DIGITAL SCANS OF TASK ORDER, 13.1.1.2 TASK HISTORY. User can also click to open further screens of 13.1.2 CREW (REFERS TO FIG. 8 IN THE DOCUMENT), 13.1.3 MANUALS (7.13.10 REFERS TO MANUAL SECTION OF THE FIGURE MODELLED FOR THIS SECTION), 13.1.4 MECHANICAL COMPONENTS (REFERS TO FIG. 11 IN THE DOCUMENT), 13.1.5 CURRENT STATUS which opens further screens of 13.1.5.1 COMPLETION STATUS (PICTURES/DIAGRAMS), 13.1.6 AI ANALYTICS which leads to further screens of 13.1.6.1 AI BASED ANALYTICS SCREENS. User can also communicate using 7.B.3 REFERS TO COMMUNICATION SECTION IN THE FIG. 7.B OF THE DOCUMENT. User can also click to open screens of video feed 7.B.5 REFERS TO VIDEO FEED SECTION IN THE FIURE 7.B OF THE DOCUMENT. User can also access Issuing and Deliveries schedule of Items and open further screens (REFERS TO FIG. 15 OF THE DOCUMENT). User can also click to open screens of 12.4 REFERS TO STOCK IN THE FIG. 12 OF THE DOCUMENT. User can also click to open screens of 13.2 MAINTAINENCE RECORDS which further opens to screens of 13.2.1 RECORDS SCREEN OPEN. User can also communicate to manufacturers by 7.B.3 COMMUNICATION TO MANFACTURER (COMMUNICATION SECTION IN THE FIG. 7.8 OF THE DOCUMENT).

FIG. 14 depicts 7.6.9.2 CANTEEN. User clicks to open screens of 14.1 ACTUAL PHOTO OF CANTEEN, live GPS coordinates 14.2 DETAILS OF GPS COORDINATES. User can click to see Canteen crew screens (REFERS TO FIG. 8 FROM DOCUMENT CREW SECTION). User can click to see sensor feed of canteen using 7.B.7 REFERS TO SENSOR SECTION FROM FIG. 7 IN THE DOCUMENT. User can click to communicate with 7.B.3 REFERS TO COMMUNICATION SECTION FROM FIG. 7 IN THE DOCUMENT. User can also click to see screens of 12.4 REFES TO CANTEEN STOCK FROM SECTION IN THE FIG. 12 OF THE DOCUMENT. User can also click to open screens of 15 REFERS TO ISSUING& DELIVERY SCHEDULE IN FIG. 15 OF THE DOCUMENT. User can also click to open screens of 14.3 MENU which further opens to screens of 14.3.1 DAILY and 14.3.1.1 TO 14.3.1.3 CREW COOKS (REFERS TO CREW SECTION IN FIG. 8 OF THE DOCUMENT, 14.3.1.4 BREAKFAST, 14.3.1.5 LUNCH, 14.3.1.6 DINNER, 14.3.1.7 FEEDBACK AND SURVEY REPORTS. User can click to open further screens of 14.3.2 WEEKLY, 14.3.3 MONTHLY. User can also see screens of duty roster of the canteen (8.8 REFERS TO DUTY ROSTER IN FIG. 8 OF THE DOCUMENT). User can click to see screens of 14.4 SECTION DETAILS which leads to further screens of 14.4.1 CANTEEN BLUEPRINT, 14.4.1.1 SEATING PLAN OF CANTEEN, 14.4.2 FOOD WASTAGE leading to further screens of 14.4.2.1 ITEM, 14.4.2.2 WASTE, 14.4.2.3 AI which leads to further screens of 14.4.2.3.1 AI BASED ANALYTICS, 14.4.3 FOOD CONSUMPTION which leads to further screens of 14.4.3.1 ITEM, 14.4.3.2 WASTE. User can also click to see Ai based analytics of screens 14.4.3.3 AI and 14.4.3.3.1 AI BASED ANALYTICS.

FIG. 15 depicts the screens for 15.1 ISSUING AND DELIVERIES SCHEDULE. User clicks to open further screens 15.1.1 ITEM which leads to 12.4.1 REFERS TO SECTION UDER ITEMS IN FIG. 12 OF THE DOCUMENT. User can also click to open screens of 15.1.2 ISSUED TO which further leads to screens of 15.1.2.1 DIGITAL SCANS OF RECORDS, 15.1.2.2 ISSUED TO PERSON DETAILS (REFERS TO CREW SECTION IN FIG. 8 OF THE DOCUMENT). User can also click to open more screens of 15.1.3 IN CHARGE DETAILS which opens to further screens of 15.1.3.1 DIGITAL SCANS OF RECORDS OPEN, 15.1.3.2 IN CHARGE PERSON FROM FIG. 8 OPENS FROM THIS DOCUMENT. User can click to open screens of 15.1.4 DELIVERIES SCHEDULE which opens further screens of 15.1.4.1 DAY and 15.1.4.1.1 ITEM, 15.1.4.1.2 DELIVERY SCHEDULES which opens screens of 15.1.4.1.2.1 AI BASED ANALYTICS SCREEN PARAMETERS, 15.1.4.1.2.2 DIGITAL SCANS OF ALL RECORDS. User can also click to open screens of 15.1.4.2 MONTH (CLICKABLE), 15.1.4.3 YEAR (CLICKABLE) and 15.1.5 BALANCE.

FIG. 16 depicts the screens of the Ships' main bridge or control room. User clicks to open 16.1 REFERS TO ACTUAL PHOTO OF BRIDGE, 16.2 DETAILS OF BRIDGE. User can click to see video feed screens (7.B.5 REFERS TO VIDEO FEED SECTION OF FIG. 7 IN THE DOCUMENT). User can click to communicate with ship's bridge (7.B.7 REFERS TO COMMUNICATION SECTION OF FIG. 7 IN THE DOCUMENT). User can click to see all details of crew (16.3 CREW DETAILS (EACH BUTTON IS CLICKABLE OF EVERY CREW). User can click to see screens of 16.4 DUTY ROSTERS (EACH BUTTON IS CLICKABLE), 16.5 BRIDGE OPERATIONS which opens to further screens, for example 16.5.1 NAVIGATION, 16.5.2 ANTI COLLISION, 16.5.3 ROUTE PLOTTING, 16.5.4 SHIP SYSTEMS, 16.5.5 WEATHER & SEA CONDITIONS, 16.5.6 NAUTICA CENTRAL COMMAND. All required parameters can be added with more screens: 16.5.7 TO 16.5.12 ARE PORGRAMMABLE BUTTONS FOR OTHER OPERATIONS. 16.6 ALL BUTTONS FROM 16.5.1 TO 16.5.12 ARE CLICKABLE AND OPEN TO A NEW SCREEN GIVING DETAILS ABOUT EACH OPERATIONS

FIG. 17 depicts the hologram screens of a “Buoy”. When user clicks on 17.1 HOLOGRAM OF A BUOY, screens open for 17.1.1 ACTUAL PHOTO OF BUOY, 17.1.2 DETAILS ABOUT BUOY. User can also open screens for sensor feed (7.B.7 SENSOR FEED FROM FIG. 7 OF THE DOCUMEN). User can also open screens of video feed (7.B.5 VIDEO CAMERA FEED FROM FIG. 7 OF THE DOCUMENT). User can also click to open screens of 17.1.3 TSUNAMI WARNING SYSTEMS which opens further screens of 17.1.3.1 SEA LEVEL LIVE ANALYTICS FOR SUNAMI and 17.1.3.1.1 AI BASED ANALYTICS FOR TSUNAMI, 17.1.4 WATER/SEA SWELL PERIODS which opens further screens of 17.1.4.1 WATER SWELL PERIODS ANALYTICS, 17.1.4.2 AI BASED ANALYTICS SCREEN, 17.1.5 WAVE HEIGHTS which opens further screens of 17.1.5.1 SAME AS 17.1.4.1 (SWEEL PERIODS ANALYTICS BUT FOR WAVE HEIGHTS), 17.1.6 UNDER WATER CURRENTS which opens further screens of 17.1.6.1 SAME AS 17.1.4.1 (SWEEL PERIODS ANALYTICS BUT FOR WATER CURRENTS), 17.1.7 SOLAR POWER OF BUOY which opens further screens of 17.1.7.1 GAUGES SHOWING BATTERY, 17.1.7.2 BATTERY, 17.1.7.3 RETURN TO CHARGE. User can also click to open screens of 7,11,13 REFERS TO MANUAL SECTION IN THESE FIGURES (MODELLED FOR THIS SECTION), 17.1.8 WARNING LIGHT SYSYTEM which opens further screens of 17.1.8.1 ON, 17.1.8.1.1 WARNING LIGHTS CAN BE SWITCHED ON, 17.1.8.2 OFF, 17.1.8.1.2 WARNING LIGHTS CAN BE SWITCHED OFF. User can also click to open screens of 17.1.9 AUTONOMOUS FLOAT OF BUOY (REFERS TO FIG. 25 OF THE DOCUMENT).

FIG. 18 depicts the holographic screens of a “Tug Boat”. User click on hologram of Tug boat to open screens of REFERS TO SHIP SECTION OF THE FIG. 7 IN THIS DOCUMENT, 18.1 WEIGHT METRICS which opens further screens of 18.1.1 ACTUAL WEIGHT, 18.1.2 PULLED WEIGHT, 18.1.3 BUTTONS FOR Al ANALYTICS leading to screens of 18.1.3.1 AI BASED ANALYTICS SCREEN OPENS UP. User can also open analytics screens of ships services by the selected tug boat, for example 18.1.4 SHIP 1, 18.1.5 SHIP 2 etc.

FIG. 19 depicts the hologram of a “Port Berth”. When user clicks on 19.1 HOLOGRAM OF PORT BERTH, further screens open like 19.1.1 ACTUAL PHOTO, 19.1.2 DETAILS OF BERTH. User can also click to view all crew working at the port berth (8.2 CREW FROM FIG. 8 OF THIS DOCUMENT). User can click to view sensor feeds (7.B.7 REFERS TO SENSORS FROM FIG. 7 OF THIS DOCUMENT). User can click to view video feed (7.B.5 REFERS TO VIDEO FEED FROM FIG. 7 OF THIS DOCUMENT). User can also communicate with port berth using (7.B.3 REFERS TO COMMUNICATION SECTION IN THE FIG. 7 OF THIS DOCUMENT). User can click to view screens of warning light systems of port berth (17 REFERS TO FIG. 17 OF THE DOCUMENT) and 19.1.3 DOCKING SCHEDULE (REFERS TO FIG. 20 OF THE DOCUMENT). User can also click to open screens of 7, 11 & 13 REFERS TO FIGS. 7,11 & 13 OF THE MANUAL SECTIONS OF THESE FIGURES. User can click to view screens of 19.1.4 CRANES SECTION which has all cranes liked to it 19.14.1 CLICKABLE BUTTON WHICH TAKES TO FIG. 21. User can click to open screens of 19.1.5 CARGO CAPABILITY (MAPABLE FOR VARIOUS KINDS OF CARGOS and REFERS TO FIG. 22 OF THE FIGURE). User can click to view screens of 19.1.6 CONVEYNOR BELT which further opens screens of 19.1.6.1 CONVEYNOR BELT CONTAINER (REFERS TO FIG. 23 OF THE DOCUMENT) and 19.1.6.2 CONVEYNOR BELT MATERIALS (REFERS TO FIG. 23 OF THE DOCUMENT).

FIG. 20 depicts the “docking schedule” hologram screens (20.1 DOCKING SCHEDULE SCREEN HOLOGRAM). User can click to open screens of all ships 20.2 MAPABLE BUTTON FOR SHIPS (REFERS TO FIG. 7 OF THE DOCUMENT). User can also click to open screens of 20.3 DAY WISE SCHEDULE which opens screens of 20.3.1 SHIP 1 DETAILS (EFERS TO FIG. 7 OF THE DOCUMENT), 20.3.2 SHIP 2 DETAILS which opens further screens of 20.3.2.1 DOCKING SCHEDULE SCREENS OPEN. User can click to open screens of 20.4 MONTH WISE SCHEDULE, 20.5 YEARLY SCHEDULE. User can also click to open screens of 20.6 AI BASED ANALYTICS which opens to further screens of 20.6.1 AI BASED ANALYTICS.

FIG. 21 depicts the holographic screens of “Cranes” as a digital asset. User can click to open 21.1 CRANES SCREEN; ALL CRANES ARE MAPABLE HERE which opens to further screens of 21.1.1 ACTUAL PHOTO, 21.1.2 DETAILS OF CRANE, Live GPS coordinates, 21.1.3 GPS COORDINATES OF CRANE. User can also click to view video feed (7.B.3 REFERS TO VIDEO FEED IN FIG. 7 OF THE DOCUMENT OF THIS DOCUMENT). User can also communicate with each crane (7.B.7 REFERS TO COMMUNICATION FEED IN FIG. 7 OF THE DOCUMENT OF THIS DOCUMENT). User can also click to open screens of all crew on cranes (8.2 REFERS TO CREW SECTION OF THE FIG. 8 OF THIS DOCUMENT). User can also click to open screens of sensor feeds (7.B.5 SENSORS FORM FIG. 7 OF THE DOCUMENT OF THIS DOCUMENT). User can also open manuals of cranes (7,11 & 13 REFERS TO FIGS. 7,11 & 13 OF THE MANUAL SECTIONS OF THESE FIGURES). User can click to open screens of 21.1.4 CRANE SCHEDULES which opens further screens of 21.1.4.1 DAY, MONTH AND YEAR WISE SCHEDULES, 21.1.4.1.1 DETAILS OF EACH PORTION. User can click to open screens of 21.1.5 LOAD DETAILS which opens further screens of 21.1.5.1 LOAD SENSOR SCREEN, 21.1.5.2 CURRENT LIFTING, 21.1.5.3 WIGHT REMISSIBLE LIMIT. User can click to open screens of 21.1.6 DISPATCH RATE which opens further screens of 21.1.6.1 PARAMETERS and 21.6.1.1 AI PARAMETERS SCREEN OPEN. User can also click to open screens of 21.1.7 CONTAINERS ON CRANE (REFERS TO FIG. 10 OF THE DOCUMENT (MODELLED FOR THIS SECTION), 21.1.8 DELIVERY SCHEDULES (REFERS TO FIG. 15 OF THE DOCUMENT) and 17.1.8 WARNING LIGHT SYSTEMS (REFER TO FIG. 17).

FIG. 22 depicts the holographic screens 22.1 CARGO CAPABILITY SCREEN. User click to opens screens of 22.1.1 CARGO DETAILS (REFERS TO FIG. 10 OF THE DOCUMENT), 22.1.2 DISPATCH CAPACITY which opens further screens of 22.1.2.1 OPENS TO SCREEN SHOWING ALL PARAMETERS/INFORMATION/METRICS, 22.1.3 DISPATCH METRICS which opens further screens of 22.1.3.1 OPENS TO SCREEN SHOWING ALL PARAMETERS/INFORMATION/METRICS, 22.1.4 CREW HANDLING DISPATCH (REFERS TO FIG. 8 OF THE DOCUMENT), 22.1.5 DISPATCH/DELIVERY SCHEDULES which opens further screens of 22.1.5.1 OPENS TO SCREEN SHOWING ALL PARAMETERS/INFORMATION/METRICS and FIG. 15 (REFERS TO FIG. 15 OF THE DOCUMENT). User can click to open screens of 22.1.6 DISPATCH ANALYTICS which opens further screens of 22.1.6.1 TABLE SHOWING ALL PARAMETERS/INFORMATION/METRICS and 22.1.6.1.1 OPENS TO SCREEN SHOWING ALL PARAMETERS/INFORMATION/METRICS

FIG. 23 depicts the screens of “Cargo Capacity”. User can click to open screens of 23.1 CONVEYNOR BELT CONTAINERS (REFERS TO ALL FIGURE RELATED TO CONVEYNOR BELT 21 IN THE DOCUMENT and 22 & 15 OPEN UPS CONVEYNOR BELT IN THE DOCUMENT). User can click to open screens of 23.2 CONVEYNOR BELT MATERIALS (REFERS TO ALL FIGURE RELATED TO CONVEYNOR BELT 21 IN THE DOCUMENT and 22 & 15 OPEN UPS CONVEYNOR BELT IN THE DOCUMENT).

FIG. 24 depicts the digital asset of “Weigh Bridge”. User can click 24.7 HOLOGRAM OF WEIGH BRIDGE AND SCREENS OPEN to open screens of 24.1 PHOTO OF THE WEIGH BRIDGES, 24.2 DETAILS OF WEIGH BRIDGES. User can click to open screens of video feeds (7.B.3 REFERS TO VIDEO FEED IN FIG. 7 OF THE DOCUMENT OF THIS DOCUMENT) and communication screens (7.B.7 REFERS TO COMMUNICATION FEED IN FIG. 7 OF THE DOCUMENT OF THIS DOCUMENT). User can click to open screens for crew of the weigh bridge (8.2 REFERS TO CREW SECTION OF THE FIG. 8 OF THIS DOCUMENT), sensor feed screens (7.B.5 SENSORS FORM FIG. 7 OF THE DOCUMENT OF THIS DOCUMENT). User can click to open screens of 24.3 WEIGH BRIDGE DATA which opens to further screens 24.3.1 GOODS (REFERS TO FIG. 10 OF THE DOCUMENT), 24.3.2 VEHICLE (REFERS TO FIG. 25 OF THIS DOCUMENT), 24.3.3 WEIGHT, 24.3.4 VENDOR which opens to further screens of 24.3.4.1 VENDOR DETAILS, 24.3.4.2 DIGITAL SCANS, 24.3.4.2.1 SCANS OF RECORDS OPEN. User can click to open screens of 24.3.4.3 ENTRY/EXIT REGISTER, 24.4 CUSTOM RECORDS which opens to further screens of 24.4.1 REFERS TO ITEMS and 24.4.1.1 DIGITAL SCANS OF RECORDS. User can click to open screens of 24.5 AUTHORIZATION FOR WEIGH BRIDGE USE which open to more screens of 24.5.1 AUTHORIZATION RECORD OPEN. User can click to open screens of 24.6 BILLING PORTAL which opens further screens of 24.6.1 POINT OF SALES ACCESS, 24.6.1.1 BILLING ERP DETAILS, 24.6.1.2 SCREENS +LIVE BILLLING. User can click to open screens of live 24.8 GPS COORDINATES and 17.1.8 REFERS TO WARNING LIGHT SYSTEMS DIAGRAMS IN FIG. 17 OF THIS DOCUMENT. User can see all manuals by opening screens of 7,11 & 13 REFERS TO MANUAL SECTION OF FIGS. 7,11 & 13 OF THE DOCUMENT.

FIG. 25 depicts the screens of 25.1 REFERS TO HOLOGRAMIC IMAGE OF VEHICLE. User can click to open screens of 25.1.1 PHOTO OF VEHICLE, 25.1.2 DETAILS OF VEHICLE live 25.1.3 GPS COORDINATES. User can click to open screens for crew of the vehicle (8.2 REFERS TO CREW SECTION OF THE FIG. 8 OF THIS DOCUMENT. Screens for communicating (7.B.3 REFERS TO COMMUNICATION FEED IN FIG. 7 OF THE DOCUMENT OF THIS DOCUMENT), Video feed screens (7.B.5 REFERS TO VIDEO FEED IN FIG. 7 OF THE DOCUMENT OF THIS DOCUMENT), Sensor feed screens (7.B.7 SENSORS FORM FIG. 7 OF THE DOCUMENT OF THIS DOCUMENT). User can click to open screens for 25.1.4 DELIVERY SCHEDULES/DISPATCH SCHEDULES (22 & 15 REFERS TO FIG. 22&15 FROM WHICH THE SCEENS WOULD BE TAKEN FROM THIS DOCUMENT), 25.1.5 AUTHORIZATION RECORDS (24 REFERS TO AUTHORIZATION PART OF FIG. 24 ON WHICH THIS PART WILL BE MODELLED), Video feeds screens (B.5 VIDEO FEED TAKEN FROM FIG. 7 IN THIS DOCUMENT). User can click to open screens for 25.1.6 AUTONOMOUS DRIVE which opens further screens of 25.1.6.1 START BUTTON, 25.1.6.2 CONTROL SCREEN, 25.1.6.3 DESTINATION INPUT, 25.1.6.4 MAP LOCATOR, 25.1.6.5 CURRENT LOCATION, 25.1.6.6 ESTIMATED TIME OF TRAVEL & ARRIVAL. User can click to open screens of manuals (7,11 & 13 REFERS TO MANUAL SECTION IN FIGS. 7,11 & 13), Custom records (25.1.7 CUSTOM RECORDS REFERS TO FIG. 24 IN THIS DOCUMENT), 25.1.8 CARGO DETAILS (REFERS TO FIG. 10 IN THIS DOCUMENT).

FIG. 26 depicts the screens of a 26.1 STORAGE TANK HOLOGRAM. User can click to open screens of 26.2 LADDERS, 26.3 ACUTAL PHOTO OF STORAGE TANK, 26.4 DETAILS OF STORAGE TANK, Live 26.5 GPS COORDINATES. User can open screens for communication (7.B.3 REFERS TO COMMUNICATION FEED IN FIG. 7 OF THE DOCUMENT OF THIS DOCUMENT). User can open screens to view crew working at storage tanks using 8.2 REFERS TO CREW SECTION OF THE FIG. 8 OF THIS DOCUMENT. User can access sensor feed screens (7.B.7 SENSORS FORM FIG. 7 OF THE DOCUMENT OF THIS DOCUMENT), 26.6 GOODS DETAILS-REFER TO FIG. 10. User can click to open screens of manuals (7 REFERS TO FIG. 7 FROM WHICH MANUALS HAVE TO TAKEN AND MODELLED), screens of stock (12.4 REFERS TO STOCK TAKEN FROM FIG. 12 IN THIS DOCUMENT), screens of manuals (13.2 REFERS TO MAINTANENCE RECORDS FROM FIG. 13 IN THIS DOCUMENT), screens of ISSUING AND DELIVERIES SCHEDULE FROM FIG. 15& 22 OF THIS DOCUMENT, video feed screens (7.B.5 REFERS TO VIDEO FEED IN FIG. 7 OF THE DOCUMENT OF THIS DOCUMENT), Screens of 24 REFERS TO CUSTOM RECORDS FROM FIG. 24 IN THIS DOCUMENT, screens of 24 REFERS TO AUTHORIZATION RECORDS FROM FIG. 24 IN THIS DOCUMENT and screens of 17.1.8 REFERS TO WARNING LIGHT SYSTEMS IN FIG. 17 IN THIS DOCUMENT

FIG. 27 depicts the 27.1 HOLOGRAM OF PORT OPEN STORAGE-CARGO AREA IN AR-MR. User can click to open screens of 27.3 OPEN STORAGE AREA OF PORT, REFERS FIG. 26 IN THIS DOCUMENT MAPPED HERE, REFERS TO FIG. 10 OF THIS DOCUMENT, REFERS FIG. 22 OF THIS DOCUMENT, REFERS TO VEHICLE REGISTER FROM FIG. 25 IN THIS DOCUMENT, 17.1.8 REFERS TO LIGHT WARNING SYSTEMS FROM FIG. 17 IN THIS DOCUMENT. NOTE: SAME ABOVE WILL BE FOR ALL CLOSED STORAGE AREA/WAREHOUSE/ GODOWNS.

FIG. 28 refers to Hologram of a Lighthouse 28.1 HOLOGRAM OF LIGHT HOUSE. User can click to open screens of 28.2 ACUTAL PHOTO, 28.3 DETAILS, Live 28.4 GPS COORDINATES. User can click to open screens of crew at lighthouse (8.2 CREW DETAILS FROMFIGURE 8), Communication screens (7.B.3 COMMUNICATION FEED FROM FIG. 7 IN THIS DOCUMENT), Sensor feed screens (7.B.7 SENSOR FEED FROM FIG. 7 IN THIS DOCUMENT), Maintenance records (13.2 REFERS TO MAINTANENCE RECORDS IN FIG. 13, Screens of 17.1.8 REFERS TO WARNING LIGHT SYSTEMS IN FIGS. 17 and 7.B.5 REFERS TO VIDEO FEED IN THE FIG. 7.

FIG. 29 depicts 29.1 REFERS TO HOLOGRAM OF SECURITY TOWER. User can click to view screens of 29.2 REFERS TO ACTUAL PHOTO OF THE SECURITY TOWER, 29.3 DETAILS ABOUT THE SECURITY TOWER, Live 29.4 GPS COORDINATES. User can also click to view screens of crew working at security tower (8.2 REFERS TO CREW SECTION OF THE FIG. 8 IN THIS DOCUMENT), video feed screens (7.B.3 REFERS TO VIDEO FEED SECTION OF THE FIG. 7 IN THIS DOCUMENT), Communication screens (7.B.5 REFERS TO COMMUNICATION SECTION OF THE FIG. 7 IN THIS DOCUMENT), Warning light screens (17.1.8 REFERS TO WARNING LIGHT SYSTEM SECTION OF THE FIG. 17 IN THIS DOCUMENT), sensor feed screens (7.B.7 REFERS TO SENSORS IN THE FIG. 7 OF THIS DOCUMENT), duty roster screens (8.8 REFERS TO DUTY ROSTER IN THE FIG. 8 OF THIS DOCUMENT), screens for deliveries schedules (15 & 22 REFERS TO DELIVERIES SCHEDULE FROM FIGS. 15 & 22 IN THIS DOCUMENT), screens for 29.5 AM MUNATION STOCK which further opens to screens of 29.5.1 ITEM, 29.5.1.1 ACUTAL PHOTO, 29.5.1.2 DETAILS, 29.5.1.3 DIGITAL SCANS OF RECORDS OF ITEM, 29.5.1.4 ITEM LOCATOR SENSOR, 29.5.1.5 ITEM ISSUED TO (8 REFERS TO CREW SECTION OF THE FIG. 8 IN THIS DOCUMENT), 29.5.2 ISSUED, 29.5.3 USED, 9.5.4 BALANCE. User can also click to open screens of 29.6, TARGET SYSTEMS, 29.6.1 TARGET SCREEN, 29.6.2 LOAD, 29.6.3 FIRE.

FIG. 30 depicts the digital asset of a “Train and Railway Lines” (30.1 REFERS TO HOLOGRAM OF TRAIN). User can click to open screens of “Goods Carriages” (26 REFERS TO FIG. 26 OF THIS DOCUMENT). User can click to open screens of 7 & 11 REFES TO FIG. 7&11 OF THIS DOCUMENT MODELLED FOR THIS SECTION, 30.1.1 REFERS TO ROUTE MAP which opens to further screens of 30.1.1.1 HOLOGRAM OF ROUTE, 30.1.1.1.1 ROUTE SCREEN OPENS UP, 30.1.1.1.1.1 ESTIMATED TIME OF ARRIVAL, 30.1.1.1.1.2 DISTANCE TRAVELLED, 30.1.1.1.1.3 ROUTE STOPPAGES, 30.1.1.1.1.4 OTHER INFORMATION CAN BE MAPPED, 30.1.1.1.2 TRAIN STOPPING POINT, 30.1.1.1.2.1 ACTUAL PHOTO. User can also open communication screens (7.B.7 COMMUNICATION SYSTEM FROM FIG. 7 OF THIS DIAGRAM), 30.1.1.1.2.2 MAP which opens to further screens of 30.1.1.1.2.2.1 SATTELITE IMAGE, 30.1.1.1.2.2.2 GOOGLE MAP. User can also open screens of live 30.1.1.1.2.3 GPS COORDINATES, 24.5 AUTHORIZATION RECORDS FROM FIG. 24 OF THIS DOCUMENT and 24.4 CUSTOM RECORDS FROM FIG. 24 OF THIS DOCUMENT

FIG. 31 depicts the screens of “Port Channel and Outer Sea” (31.1 PORT, 31.2 AN ICON IN HOLOGRAM REPRESENTING “PORT CHANNEL”, 31.3 RADAR FEED OF CHANNEL/OUTER SEA). User can click to view screens for all ships in water (7 REFERS FIG. 7 OF THIS DOCUMENT WHICH IS MAPPED FOR ALL SHIPS) and all Buoys (17 REFERS TO FIG. 17 OF THIS DOCUMENT WHICH IS MAPPED FOR ALL BUOYS). User can also click to view screens of 31.4 NAVIGATION FEED OF CHANNEL and 7.B.7 SENSORS FORM FIG. 7 MAPPED FOR THIS FIGURE

FIG. 32 depicts the screens of a Jetty (32.1 HOLOGRAM OF JETTY). User can click to open screens of 32.3 BERTH (19 REFERS TO FIG. 19 OF THE DOCUMENT MAPPED FOR THIS PART), 32.4 LAMPPOST (7.B.3 REFERS TO VIDEO FEED SECTION OF THE FIG. 7 IN THIS DOCUMENT, 7.B.5 REFERS TO COMMUNICATION SECTION OF THE FIG. 7 IN THIS DOCUMENT, 7.B.7 REFERS TO SENSORS IN THE FIG. 7 OF THIS DOCUMENT, 17.1.8 REFERS TO WARNING LIGHT SYSTEM SECTION OF THE FIG. 17 IN THIS DOCUMENT)

FIG. 33 depicts an example of screens of NAUTICA AI-ARTIFICIAL INTELLIGENCE COMM MAND CENTRE. 33.1 REFERS TO FIG. 2 WHICH CAN BE MODIFIED AS PER CHANGES. Similarly, NAUTICA AI must be made for all Digital Assets in NAUTICA. User can click on 33.2 SHIP AI to open further screens of 33.2.1 ALL ASSESTS (33.2.1.1 TO 33.2.1.5 MAPABLE FOR VARIOUS SHIPS). User can the select each digital asset to view further Ai based analytics of that asset (33.4 BUTTON TO CLICK FOR EACH ASSET TO GO TO ITS AI-BASED ANALYTICS)

FIG. 34 depicts an example of further screens of NAUTICA AI that open after FIG. 33. User can click to open 34.1 DESCRIPTIVE ANALYTICS AND OPERATIONS which opens into further screens of 34.1.1 SCREENS OPEN FOR EACH PARAMETER WITH ALL KINDS OF ANALYTICS & OPERATIONS, 34.1.2 BUTTONS MAPABLE FOR ALL POSSIBLE AND REQUIRED PARAMETERS LISTED. User can click to open screens of 34.2 PREDICTIVE ANALYTICS AND OPERATIONS which open further screens of 34.2.1 SCREENS OPEN FOR EACH PARAMETER WITH ALL KINDS OF ANALYTICS & OPERATIONS and 34.2.2 BUTTONS MAPABLE FOR ALL POSSIBLE AND REQUIRED PARAMETERS LISTED. User can open screens of 34.3 PRESECRIPTIVE ANALYTICS AND OPERATIONS which opens further screens of 34.3.1 SCREENS OPEN FOR EACH PARAMETER WITH ALL KINDS OF ANALYTICS & OPERATION and 34.3.2 BUTTONS MAPABLE FOR ALL POSSIBLE AND REQUIRED PARAMETERS LISTED. User can also open screens of 34.4 AI COGNITIVE ANALYTICS & OPERATIONS (WARNING: AUTONOMY GIVEN TO Al) which opens further screens of 34.4.1 SCREENS OPEN ON CLICK. NOTE: SAME HAS TO BE MADE FOR ALL NAUTICA BOXES of all DIGITAL ASSETS IN NAUTICA CENTRAL COMMAND

FIG. 35 depicts the 35.2 HOLOGRAM OF ROTATING EARTH. NOTE: ON CLICKING EARTH BUTTON IN NAUTICA CENTAL COMMAND, A 3D HOLOGRAM OF EARTH APPEARS IN AR-MR SHOWING ALL ASSETS PLUGGED INTO NAUTICA. User can click on any hologram of Digital Asset at any point of time linked to NAUTCA live on Earth and view its screens (35.1 HOLOGRAM OF ALL ASSETS WHICH CAN BE CLICKED TO OPEN THEIR SCREENS)

FIG. 36 depicts the Digital Asset of a “DRONE/UNMANNED ARIAL VEHICLE 9UAV)”. User can click to open screens of sensor feeds (7.B.7 REFERS TO SENSORS FEED FROM FIG. 7 OF THIS DOCUMENT), screens of video feeds (7.B.3 REFERS TO VIDEO FEED FROM FIG. 7 OF THIS DOCUMENT), screens of 36.1 LIDAR FEED which further opens to screens of 36.1.1 LIDAR SCREENS AND FEED OPEN. User can click to open screens of 36.2 SOLAR POWER OF DRONE,36.3 AUTONOMOUS FLIGHT which further opens to screens of 36.3.1 MAPPED AS PER AUTONOMOUS DRIVE OF FIG. 25 OF THIS DOCUMENT. User can click to open screens of 36.4 RADAR FEED which further opens to screens of 36.4.1 RADAR SCREENS OPEN UP. User can click to open screens of 36.5 SONAR FEED which further opens to screens of 36.5.1 SONAR SCREENS & FEED OPENS UP.

EXAMPLES OF ANALYTICS PARAEMETERS FOR NAUTICA AI-ARTIFICIAL INTELLIGENCE ARE BELOW. MORE PARAMETERS CAN BE ADDED AS REQUIRED.

| DEPARTMENT | AI ANALYTICS PARAMENTERS |
|---|---|
| Accounts | Revenue |
| Accounts | Receivables |
| Accounts | Payables |
| Accounts | Expense Control |
| Accounts | Maintaining Books |
| Accounts | Taxation |
| Accounts | Reporting |
| Accounts | Customs |
| Accounts | SLA |
| BD | Sales Target |
| BD | Commodity Ratio (Product Mix) |
| BD | Pricing |
| BD | Team P&L |
| BD | Customer Base |
| BD | Customer complaints |
| Cargo Operations | Revenue |
| Cargo Operations | New Initiatives |
| Cargo Operations | Cost Management |
| Cargo Operations | SLA \| New Initiatives |
| Cargo Operations | Customer Satisfaction |
| Cargo Operations | Preparedness |
| Cargo Operations | Not Prepared |
| Cargo Operations | Crane, Berth & Tippers etc |
| Cargo Operations | Discharge Rate |
| Cargo Operations | Capacity Management |
| Cargo Operations | Berth Availability |
| Cargo Operations | SLA Management |
| Cargo Operations | Loss % |
| Cargo Operations | Customer Retention |
| Cargo Operations | Preparedness |
| Commercials | Procurement P&L |
| Commercials | Effective Procurement |
| Commercials | SLA |
| Commercials | Compliance |
| Commercials | CSAT |
| Commercials | Preparedness |
| Commercials | Not Prepared |
| EHS & Safety | EHS Budget |
| EHS & Safety | New Initiatives |
| EHS & Safety | Certificates |
| EHS & Safety | Compliance |
| EHS & Safety | GreenBelt |
| EHS & Safety | Safety Awareness |
| EHS & Safety | Accidents |
| EHS & Safety | Preparedness |
| EHS & Safety | Not Prepared |
| Electrical Engineering | Maintenance Electrical |
| Electrical Engineering | Mechanization |
| Electrical Engineering | SLA Management |
| Electrical Engineering | SLA Management |
| Electrical Engineering | SLA Mechanization |
| Electrical Engineering | Customer Satisfaction |
| Electrical Engineering | Preparedness |
| Electrical Engineering | Not Prepared |
| Finance | Budget |
| Finance | Team P&L |
| Finance | Closing Books |
| Finance | MIS |
| Finance | Cashflow |
| Finance | Auditing & Statutory Compliance |
| Finance | Expense Control |
| Finance | Accounts Payable |
| Finance | Reporting |
| Finance | SLA |
| General | Port Policy |
| General | Company Policy |
| General | L&D |
| General | Innovation |
| General | Innovation |
| General | L&D |
| General | Innovation |
| General | Attrition |
| HR | HR Cost |
| HR | Payroll & Pay slips |
| HR | Payroll & Pay slips |
| HR | Employee Queries |
| HR | Employee Queries |
| HR | Recruiting closure |
| HR | Employee Engagement |
| IT | New Initiatives |
| IT | Maintenance |
| IT | SLA Management |
| IT | New Initiatives SLA |
| IT | Customer Satisfaction |
| IT | Preparedness |
| IT | Not Prepared |
| Marine Operations & Security | Cost Management |
| Marine Operations & Security | Pilot Captain & Tugs Availability |
| Marine Operations & Security | Navigational Aid |
| Marine Operations & Security | SLA Management |
| Marine Operations & Security | Dredging |
| Marine Operations & Security | Customer Retention |
| Marine Operations & Security | Customer Satisfaction |
| Marine Operations & Security | Preparedness |
| Marine Operations & Security | Not Prepared |
| Mechanical Engineering | Maintenance Mechanical |
| Mechanical Engineering | New Initiatives |
| Mechanical Engineering | Utilization of Resources |
| Mechanical Engineering | SLA Management |
| Mechanical Engineering | SLA Management |
| Mechanical Engineering | Customer Satisfaction |
| Mechanical Engineering | Preparedness |
| Mechanical Engineering | Not Prepared |
| Over all Engineering | maintenance New Projects |
| Over all Engineering | Operating Costs |
| Over all Engineering | Deadline |
| Over all Engineering | SLA Management |
| Overall Engineering | Customer Satisfaction |
| Over all Engineering | Preparedness |
| Over all Engineering | Not Prepared |
| Overall Cargo Ops | Cost Management |
| Overall Cargo Ops | Capacity Management |
| Overall Cargo Ops | SLA Management |
| Overall Cargo Ops | Customer Retention |
| Overall Cargo Ops | Customer Satisfaction |
| Overall Cargo Ops | Preparedness |
| Overall Cargo Ops | Not Prepared |
| Overall Engineering | Maintenance Electrical |
| Civil Engineering | Maintenance Civil Projects |
| Overall Engineering | New Projects P&L |
| Overall Engineering | SLA Management |
| Overall Engineering | New Initiatives |
| Overall Engineering | Customer Satisfaction |
| Overall Engineering | Preparedness |
| Overall Engineering | Not Prepared |
| Railways | Rail Loading Cost |
| Railways | Discharge Rate |
| Railways | Capacity Management |
| Railways | Berth Availability |
| Railways | SLA Management |
| Railways | Loss % |
| Railways | Customer Retention |
| Railways | Customer Satisfaction |
| Railways | Preparedness |
| Railways | Not Prepared |
| Security | Security P&L |
| Security | Utilization of Employees |
| Security | Utilization of Resources |
| Security | Threat/Safety |
| Security | SLA Management |
| Security | Port Policy |
| Security | Company Policy |
| Security | Preparedness |
| Security | Not Prepared |
| Tank Farm | Cost Management |
| Tank Farm | Capacity Management |
| Tank Farm | Evacuation Capacity |
| Tank Farm | SLA Management |
| Tank Farm | Loss % |
| Tank Farm | Customer Retention |
| Tank Farm | Customer Satisfaction |
| Tank Farm | Preparedness |
| Tank Farm | Not Prepared |
| Warehouse Management | Cost Management |
| Warehouse Management | Revenue from WH |
| Warehouse Management | Evacuation Capacity |
| Warehouse Management | SLA Management |
| Warehouse Management | Loss % |
| Warehouse Management | Customer Retention |
| Warehouse Management | Customer Satisfaction |
| Warehouse Management | Preparedness |
| Warehouse Management | Not Prepared |
| Project | Total Tasks |
| Project | Total Sub Projects |
| Project | Activity Time Line (Start Dt, End Dt) |
| HR | CTC by Department |
| HR | Designation \| Avg CTC vs Years |
| | of experience |
| HR | Salary breakup Details |
| HR | Education \| Avg CTC vs Years |
| | of experience |
| HR | Total CTC and Count of Employees |
| HR | Average Working Hours by Employee |
| HR | Total Present/Absent |
| HR | Leave by Department |
| HR | Late In/Early Out by Month |
| HR | Present/Absent by Month |
| HR | Leave Type |
| HR | Department wise Hike % vs Rating |
| HR | Hike % vs Performance Rating |
| HR | Individual \| Hike % vs Rating |
| HR | Hike % vs Revenue (in Crores) |
| HR | No of Promotions |
| HR | Avg Rating \| Hike \| Revenue |
| HR | Total Contract Labour |
| HR | Labour Skills and Nature of work |
| HR | Labour by Department |
| HR | Education by Employee |
| HR | Total Experience in KPPL & outside |
| HR | Employee Age |
| HR | How many Emp likely to Leave and Stay |
| Finance | Total Cost and Cost by Location |
| Finance | Cost by month and category |
| Finance | Cost Details |
| Finance | Tonne \| Expenses \| Revenue Details |
| | by month by value (Actual vs Budget) |
| Finance | Identified Top Expenses |
| Finance | Expenses details by month (Actual |
| | vs Budget) |
| Finance | Revenue details by month (Actual |
| | vs Budget) |
| Finance | P&L Details summary |
| Finance | Revenue \| Expenses by Category |
| Finance | Comparison of Actual and Budgeted |
| | Expenses and Revenue |

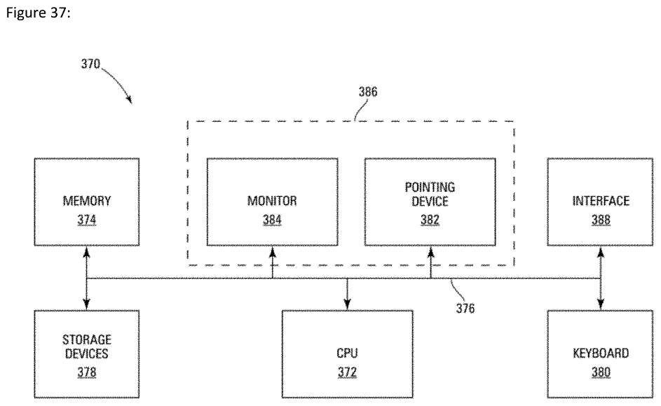

FIG. 37 and the related discussion provide a brief, general description of a suitable computing environment in which embodiments of the present disclosure can be implemented. Although not required, components of the system can be implemented at least in part, in the general context of computer-executable instructions, such as program modules, being executed by a computer 370 which may be connected in wired or wireless fashion to smart eyewear (e.g., VR glasses and/or projectors). Generally, program modules include routine programs, objects, components, data structures, etc., which perform particular tasks or implement particular abstract data types. Those skilled in the art can implement the description herein as computer-executable instructions storable on a computer readable medium. Moreover, those skilled in the art will appreciate that the invention may be practiced with other computer system configurations, including multi-processor systems, networked personal computers, mini computers, main frame computers, smart screens, mobile devices (e.g., smart phones, tablets) and the like. Aspects of the invention may also be practiced in distributed computing environments where tasks are performed by remote processing devices that are linked through a communications network. In a distributed computer environment, program modules may be located in both local and remote memory storage devices.

The computer 370 comprises a conventional computer having a central processing unit (CPU) 372, memory 374 and a system bus 376, which couples various system components, including memory 374 to the CPU 372. The system bus 376 may be any of several types of bus structures including a memory bus or a memory controller, a peripheral bus, and a local bus using any of a variety of bus architectures. The memory 374 includes read only memory (ROM) and random access memory (RAM). A basic input/output (BIOS) containing the basic routine that helps to transfer information between elements within the computer 370, such as during start-up, is stored in ROM. Storage devices 378, such as a hard disk, a floppy disk drive, an optical disk drive, etc., are coupled to the system bus 376 and are used for storage of programs and data. It should be appreciated by those skilled in the art that other types of computer readable media that are accessible by a computer, such as magnetic cassettes, flash memory cards, digital video disks, random access memories, read only memories, and the like, may also be used as storage devices. Commonly, programs are loaded into memory 374 from at least one of the storage devices 378 with or without accompanying data.

Input devices such as a keyboard 380 and/or pointing device (e.g. mouse, joystick(s)) 382, or the like, allow the user to provide commands to the computer 370. A monitor 384 or other type of output device can be further connected to the system bus 376 via a suitable interface and can provide feedback to the user. If the monitor 384 is a touch screen, the pointing device 382 can be incorporated therewith. The monitor 384 and input pointing device 382 such as mouse together with corresponding software drivers can form a graphical user interface (GUI) 386 for computer 370. Interfaces 388 on the system controller 300 allow communication to other computer systems if necessary. Interfaces 388 also represent circuitry used to send signals to or receive signals from the actuators and/or sensing devices mentioned above. Commonly, such circuitry comprises digital-to-analog (D/A) and analog-to-digital (A/D) converters as is well known in the art.

Although the present invention has been described with reference to preferred embodiments, workers skilled in the art will recognize that changes may be made in form and detail without departing from the spirit and scope of the invention.

What is claimed is:

1. A global maritime mobility, operation and execution system comprising:
a computing device with a display device, memory, at least one processor, and machine-readable instructions executable with the at least one processor, the computing device configured to generate a live hologram display of available physical assets complete with monitoring, visualization, communication, operations and execution capabilities, the hologram projections generated using augmented reality-mixed reality, wherein the hologram display is data-infused with autonomous artificial intelligence-powered descriptive, predictive, prescriptive and cognitive analytics and operative capabilities for global maritime systems, and wherein each hologram of the physical assets in the hologram display having one or more data points.

2. The system as claimed in claim 1 wherein the live hologram display provides live holographic visualizations of maritime assets and a geographic space that includes seas, waterways and land.

3. The system as claimed in claim 2 wherein the live hologram display includes artificial intelligence analytics in real time.

4. The system as claimed in claim 2, wherein the geographic space is configurable to select any country or combine all countries.

5. The system as claimed in claim 1 wherein the system itself creates absolute situational awareness by providing real-time information on the current situation and execution and operational capabilities.

6. The system as claimed in claim 1 wherein functions of the system are touch enabled and voice command enabled.

7. The system as claimed in claim 1, wherein an authority level of access per screen and function is decided by the computing device pursuant to a user specification.

8. The system as claimed in claim 1, wherein at least one hologram of the live hologram display is either hand-held or capable of being moved around

9. The system as claimed in claim 1, wherein the display device comprises smart eye wear with holographic projection capability.

10. A method of executing the system as claimed in claim 9, the method comprising:
activating the smart eye wear; and
after activating the smart eye wear, displaying a hologram box with the smart eye wear while still allowing a user wearing the smart eye wear to see surrounding physical environment.
